(19) United States
(12) Patent Application Publication
(10) Pub. No.: US 2017/0075920 A1
(43) Pub. Date: Mar. 16, 2017

(54) SYSTEM AND METHODS FOR DETECTING PRECISE FILE SYSTEM EVENTS FROM A LARGE NUMBER AND ASSORTMENT OF AUTOMATICALLY-GENERATED FILE SYSTEM EVENTS DURING USER OPERATIONS

(71) Applicant: GARY HOWARD MCKAY, CAMBERWELL (AU)

(72) Inventor: GARY HOWARD MCKAY, CAMBERWELL (AU)

(21) Appl. No.: 14/849,593

(22) Filed: Sep. 10, 2015

(51) Int. Cl. G06F 17/30

(52) U.S. Cl. CPC G06F 17/30168; G06F 17/30194; G06F 17/30174

(57) ABSTRACT

System and methods for precise detection of file system events for user operations during file sharing and synchronization across different end user devices and geographical locations. Corresponding to a user operation, a multitude of file system events is automatically generated. For different types of user operations (e.g. ‘File Create’, ‘File Rename’ et al.) involving different types of files (e.g. Microsoft PowerPoint, Microsoft Word, PDF et al.), an assortment of file system events are automatically generated. A profiler that detects the exact file system events for corresponding user operations is designed. Methods for identifying and matching the detected file system events to corresponding user operations are developed. Through those developed methods, further methods are developed for large-sized file sharing (e.g. large file copy) between multiple end users and resolving conflicts in simultaneous file change requests.

### SECTION 1.0 BACKGROUND

The notion of file sharing and synchronization is facing significant challenges to manage business data across a variety of end-user devices and Bring Your Own Device (BYOD) features. A general embodiment of file sharing and synchronization for business data is the case where end users (typically Small and Medium Enterprises (SMEs)) have the opportunity of choosing their own preferred file storage system as part of their own hardware located at their own premises. This embodiment imparts end users the ability to create their own private cloud for internal and external use. This embodiment further imparts end users the ability to leverage upon the use of an IT reseller's file storage and/or an IT service provider's private cloud storage in conjunction to create highly scalable hybrid cloud storage to store their data.

A second general embodiment of file sharing and synchronization for business data is the case where the same user accesses and edits the same file from multiple locations using different devices (e.g. Tablet, Mac, PC, Smartphone et al.). The type of devices are unrestricted as in the knowledge of existing state-of-the-art communication, information processing and display technologies.

A third general embodiment of file sharing and synchronization for business data is the case where a group of users using different end devices located at multiple geographies access and edit the same file simultaneously. The scope of multiple geographies is unrestricted by the coverage area (e.g. suburb, city, multiple cities in the same country, multiple cities in different countries, intercontinental locations et al.)

The first major challenge in realizing these general embodiments is to achieve scalability in file synchronization across multiple end user devices. As the type and volume of new end user devices increases with deeper market proliferation, realizing seamless instantaneous file synchronization for file access/edit purposes will be difficult.

The second major challenge in realizing these general embodiments is to achieve large-sized file sharing between multiple end users. For business data, this is particularly of relevance as personnel from multiple business units located at different geographies might want to review and edit a set of common documentation libraries simultaneously. In that case, large file sharing with correct change versions becomes difficult.

There is thus a need for a system and methods that can enable scalability in file synchronization across multiple end user devices and can further enable large file sharing between multiple end users. A comprehensive due diligence on state-of-the-art file sharing and synchronization products available in prior art distinctly shows the limited features in current solutions and techniques for solving the scalability and large file sharing problems.

### SECTION 2.0 HISTORY OF RELATED ART

### References Cited

U.S. Patent Documents

| | | |
|---|---|---|
| U.S. Patent No. 8,370,298 | February 2013 | Strong et al. |
| U.S. Patent No. 8,019,900 | September 2011 | Sekar, et al. |
| U.S. Patent No. 7,680,843 | March 2010 | Panchbudhe, et al. |
| U.S. Patent No. 7,555,482 | June 2009 | Korkus |
| U.S. Patent No. 7,725,527 | May 2010 | Janssen, et al. |
| U.S. Patent No. 8,468,120 | June 2013 | Gupta, et al. |
| U.S. Patent No. 8,438,612 | May 2013 | Faitelson, et al. |
| U.S. Patent No. 6,785,789 | August 2004 | Kekre, et al. |
| 2012/0331108 A1 | December 2012 | Ferdowsi, et al. |
| 2013/0041931 A1 | February 2013 | Brand, Aron |
| 2011/0191299 A1 | August 2011 | Huynh Huu; |
| | | Hanh, et al. |
| 2013/0005487 A1 | January 2013 | Frazzini, et al. |
| 2013/0073601 A1 | March 2013 | Jenkins, et al. |
| 2013/0151850 A1 | June 2013 | Bugenhagen |
| 2005/0257048 A1 | November 2005 | Willman |
| 2012/0221550 A1 | August 2012 | Korkus, et al. |
| 2013/0074100 A1 | March 2013 | Faitelson, et al. |
| U.S. Patent No. 8,504,519 | August 2013 | Sachs, et al. |
| 2012/0005269 A1 | January 2012 | Janssen, et al. |
| 2011/0067027 A1 | March 2011 | Jansen, et al. |
| U.S. Patent No. 8,261,245 | September 2012 | Branda, et al. |
| U.S. Patent No. 8,131,739 | March 2012 | Wu et al. |
| U.S. Patent No. 7,529,811 | May 2009 | Thompson |
| U.S. Patent No. 8,332,942 | December 2012 | Small |
| U.S. Patent No. 7,987,204 | July 2011 | Stokes |
| U.S. Patent No. 8,640,232 | January 2014 | Small |
| 2006/0129584 A1 | June 2006 | Hoang, et al. |
| U.S. Patent No. 8,176,007 | May 2012 | Hoang, et al. |
| U.S. Patent No. 8,751,639 | June 2014 | Griffiths |
| U.S. Patent No. 7,188,118 | March 2007 | Borthakur, et al. |
| 2013/0290385 A1 | October 2013 | Morrey, et al. |
| U.S. Patent No. 7,437,375 | October 2008 | Borthakur, et al. |
| U.S. Patent No. 8,055,613 | November 2011 | Mu, et al. |
| 2007/0011207 A1 | January 2007 | Vishnubhotla |
| U.S. Patent No. 6,874,004 | March 2005 | Jolly |
| U.S. Patent No. 6,826,574 | November 2004 | Colbath |
| U.S. Patent No. 7,716,647 | May 2010 | Loh, et al. |
| U.S. Patent No. 6,754,890 | June 2004 | Berry, et al. |
| U.S. Patent No. 8,171,340 | May 2012 | Molnar, et al. |
| U.S. Patent No. 8,176,007 | May 2012 | Hoang, et al. |
| U.S. Patent No. 8,341,123 | December 2012 | Irving, et al. |
| 2013/0282788 A1 | October 2013 | Hylick, et al. |
| U.S. Patent No. 5,928,329 | July 1999 | Clark, et al. |
| U.S. Patent No. 8,370,298 | February 2013 | Strong, et al. |
| U.S. Patent No. 7,870,226 | January 2011 | Anna, et al. |
| U.S. Patent No. 6,101,507 | August 2000 | Cane, et al. |
| U.S. Patent No. 7,953,785 | May 2011 | Li, et al. |
| 2014/0053227 A1 | February 2014 | Ruppin, et al. |
| U.S. Patent No. 8,296,261 | October 2012 | Pomerantz |
| U.S. Patent No. 6,636,872 | October 2003 | Heath, et al. |
| 2012/0296867 A1 | November 2012 | Berkvens-Matthijsse |
| 2014/0143201 A1 | May 2014 | Hwang |
| 2009/0271447 A1 | October 2009 | Shin, et al. |
| 2014/0101103 A1 | April 2014 | Chan, et al. |
| U.S. Patent No. 8,538,917 | September 2013 | Piccirelli, et al. |
| 2014/0214765 A1 | July 2014 | Jiang, et al. |
| 2014/0181057 A1 | June 2014 | Euresti, et al. |
| U.S. Patent No. 6,460,055 | October 2002 | Midgley, et al. |
| U.S. Patent No. 8,200,623 | June 2012 | Liu, et al. |
| U.S. Patent No. 8,117,173 | February 2012 | Gurevich, et al. |
| 2013/0191339 A1 | July 2013 | Von Haden, et al. |
| U.S. Patent No. 6,697,805 | February 2004 | Choquier, et al. |
| U.S. Patent No. 7,778,962 | August 2010 | Shah, et al. |
| U.S. Patent No. 8,214,517 | July 2012 | Dubnicki, et al. |
| U.S. Patent No. 5,950,198 | September 1999 | Falls, et al. |
| U.S. Patent No. 7,885,925 | June 2008 | Strong, et al. |
| 2013/0282790 A1 | October 2013 | Catmull, et al. |
| U.S. Patent No. 8,707,035 | April 2014 | Hartley |
| U.S. Patent No. 7,680,838 | March 2010 | Shaw |
| U.S. Patent No. 8,195,608 | June 2012 | Arcese, et al. |
| U.S. Patent No. 6,654,746 | November 2003 | Wong, et al. |
| 2013/0282857 A1 | October 2013 | Stamper |
| 2013/0275509 A1 | October 2013 | Micucci, et al. |
| 2004/0039889 A1 | February 2004 | Elder, et al. |
| U.S. Patent No. 6,085,192 | July 2000 | Mendez, et al. |
| U.S. Patent No. 7,689,598 | March 2010 | Ching, et al. |
| U.S. Patent No. 8,489,548 | July 2013 | Wang, et al. |
| 2013/0031155 A1 | January 2013 | Terrano, et al. |
| U.S. Patent No. 8,595,381 | November 2013 | Long |
| U.S. Patent No. 8,200,791 | June 2012 | Callanan, et al. |
| 2014/0013008 A1 | January 2014 | Lazarus, et al. |
| 2014/0040353 A1 | February 2014 | Sebastian, et al. |
| 2014/0067929 A1 | March 2014 | Kirrigin, et al. |
| U.S. Patent No. 8,688,434 | April 2014 | Birnbaum, et al. |
| 2007/0130145 A1 | June 2007 | Pedersen, et al. |
| U.S. Patent No. 6,374,268 | April 2002 | Testardi |
| U.S. Patent No. 7,634,507 | December 2009 | Atluri, et al. |

Australian Patent Documents

| | | |
|---|---|---|
| 2008205545 | January 2008 | Bradley, William |
| | | Benjamin |
| 2006223566 | March 2006 | Strickland, Mark |
| 2004216651 | September 2004 | Lieuallen et al. |
| 2003281646 | July 2003 (Lapsed) | Kalker et al. |
| 2003278521 | November 2003 (Lapsed) | Rooney, John G |
| 2003226229 | April 2003 (Lapsed) | Aboulhosn et al. |
| 2003217613 | February 2003 (Lapsed) | Toshev et al. |
| 2003283994 | October 2003 (Lapsed) | Keith et al. |
| 2002344297 | May 2002 | Kimos |
| 1998061515 | February 1998 (Lapsed) | Cane et al. |
| 2011338481 | December 2011 | Zhu et al. |

European Patent Documents

| | | |
|---|---|---|
| EP1913492 | August 2006 | Li et al. |
| EP12856915 | June 2013 | Wu et al. |
| EP12853531 | July 2012 | Zhang et al. |
| EP12853506 | November 2012 | Smith, Michael |
| EP12170229 | May 2012 | Kaila et al. |
| EP09830070 | December 2009 | Similius, Kim |
| | | Kristian |
| EP08874249 | December 2008 | Zhang et al. |
| EP06740234 | April 2006 | Langan et al. |
| EP05818799 | November 2005 | Strong et al. |
| EP00930330 | May 2000 | Dickinson, Peter |
| EP1977348 | October 2008 | Irving, et al. |
| EP2248032 | November 2010 | Jann, et al. |
| EP2727014 | May 2014 | Evans, et al. |

WIPO Publications (PCT Applications)

| | | |
|---|---|---|
| WO/2012/138994 A2 | April 2012 | Oman et al. |
| WO/2002/093313 A2 | May 2002 | Chandy et al. |
| WO/2012/149884 A1 | April 2012 | Cheng et al. |
| WO/2013/075563 A1 | October 2012 | Suan et al. |
| WO/2000/049537 A2 | August 2000 | Bhanjois et al. |
| WO/2012/125204 A2 | September 2012 | Savenok et al. |
| WO/2014/047606 A2 | March 2014 | Lin et al. |
| WO/2013/128331 A1 | September 2013 | Wendt, et al. |
| WO/2007/087109 A2 | August 2007 | Chaudhri |
| WO/2013/178528 A1 | December 2013 | Le et al. |
| WO/2013/054196 A2 | April 2013 | Storm |
| WO/2013/109552 A1 | July 2013 | Tse, et al. |

### Other Relevant Publications

1. Schandl, Bernhard and Popitsch, Niko, “Linking File Systems into the Linked Data Cloud with TripFS,”, in proceedings of LDOW 2010, Apr. 27, 2010, pp. 1-10
2. Stets R. J., Hunt, G. C., Scott M. L., “Component-based APIs for versioning and distributed applications”, in IEEE Journal of Computers, Vol. 32, Issue 7, July 1999, pp. 54-61
3. Suel, T., Noel, P., Trendafilov, D., “Improved file synchronization techniques for maintaining large replicated collections over slow networks”, in proceedings of ICDE 2004, April 2004, pp. 153-164
4. Haiyang, W., Shea, R., Feng W., J. Liu, “On the impact of virtualization on Dropbox-like cloud file storage/synchronization services”, in proceedings of IWQoS 2012, June 2012, pp. 1-9
5. Hao Y., Irmak, U., Suel, T., “Algorithms for Low-Latency Remote File Synchronization”, in proceedings of IEEE INFOCOM 2008, April 2008
6. Hac, A., “A distributed algorithm for performance improvement through file replication, file migration, and process migration”, in IEEE Transactions on Software Engineering, Volume 15, Issue 11, November 1989, pp. 1459-1470
7. Kumar A., “Performance Analysis of a hierarchical quorum consensus algorithm for replicated objects”, in proceedings of 10th International Conference on Distributed Computing Systems, June 1990, pp. 378-385
8. Irmak, U., Mihaylov, S., Suel, T., “Improved single-round protocols for remote file synchronization”, in proceedings of IEEE INFOCOM 2005, March 2005, Volume 3, pp. 1665-1676
9. Shuang, Q., Jingyu, Z., Tao Y., “Versioned File Backup and Synchronization for Storage Clouds”, in proceedings of 13th IEEE/ACM International Symposium on Cluster, Cloud and Grid Computing, May 2013, pp. 302-310
10. Di Sano, M., Di Stefano, A., Morana, G., Zito, D., “File System As-a-Service: Providing Transient and Consistent Views of Files to Cooperating Applications in Clouds”, in proceedings of 2012 IEEE 21st International Workshop on Enabling Technologies: Infrastructure for Collaborative Enterprises, June 2012, pp. 173-178
11. Peek, D., Terry, D. B., Ramasubramanian, V., Walraed-Sullivan, M., Rodeheffer, T. L., Wobber, T., “Fast encounter-based synchronization for mobile devices”, in proceedings of 2007 2nd International Conference on Digital Information Management, October 2007, Volume 2, pp. 750-755
12. Ratner, D., Reiher, P., Popek, Gerald J., “Roam: a scalable replication system for mobile computing”, in proceedings of 10th International Workshop on Database and Expert Systems Applications, September 1999, pp. 96-104

### Relevant State-of-the-Art Tools

1. Inotify, IBM—File System Event Monitoring for Linux 2.6 Kernel—http://www.ibm.com/developerworks/library/l-inotify/
2. Introduction to Monitoring File System Events, Windows, Microsoft Developer Network (MSDN), http://msdn.microsoftcom/en-us/library/ch2s8yd7%28v=vs.71%29.aspx/css
3. File System Events API , Apple Developers—Monitoring file changes with File System Events API—http://developer.apple.com/library/mac/featuredarticles/FileSystemEvents/index.html
4. Watch Services API, Oracle—Watching a directory for changes—http://docs.oracle.com/javase/tutorial/essential/io/notification.html
5. Building Windows 8, Building the Next Generation File System for Windows: ReFS, http://blogs.msdn.com/b/b8/archive/2012/01/16/building-the-next-generation-file-system-for-windows-refs.aspx
6. SQLite, http://www.squlite.org
7. Solid File System (SolFS), EldoS Corporation, https://www.eldos.com/solfs/

### Cited Research for Implementing This Invention's Methods

1. Hoare, C. A. R., Communicating Sequential Processes, 2004, Prentice Hall International, ISBN 0-13-153271-5, http://www.usingcsp.com/cspbook.pdf
2. OpenedFilesView v1.52 http://www.nirsoft.net/utils/opened files view.html

From the different file sharing and synchronization types and methods studied in the prior art, the limitation of methods for precise file system event detection for user operations can be inferred. To achieve scalability in file synchronization across an increasing number of multiple end user devices, capability of detecting precise file system events and associating them with corresponding user operation types (e.g. file create, file rename, file delete et al.) is required. Further, methods that capture exact file system events for large-sized file sharing (e.g. file copy) between multiple end users and resolve conflicts in simultaneous file change requests are limited in the prior art.

### SECTION 3.0 SUMMARY OF THE PRESENT INVENTION

This invention develops the capability of identifying a single file system event from an automatically generated sequence of multiple file system events upon a single user operation.

On the path to developing this capability, this invention develops methods that can uniquely detect the exact file system event generated by a single user operation (e.g. file create, file rename et al).

This invention further develops methods that overcome the challenge of masking extraneous file system events generated during a single user operation.

This invention further develops methods that detect file system events for new folder, sub-folder and file creation during directory sharing for subsequent replication.

This invention further develops methods that overcome the challenge of large file copy detection. An embodiment of this invention is bridging the notion of inability to access any file during an ongoing file copy operation. The normative error that is obtained in this attempt is an access sharing violation that is used as an indicative file system event of simultaneous file access and/or copy.

This invention further develops methods that detect file download and consequential user operations based on file instance differences between a client and server. The technical challenge of overcoming simultaneous file changes by multiple end users is embodied in this invention as a Request Queue Framework.

This invention further develops methods that resolve conflicts in simultaneous file change requests by multiple end users.

### SECTION 4.0 BRIEF DESCRIPTIONS OF THE DRAWINGS

The foregoing summary, as well as the following description of the invention, is better understood when read with the appended drawings. For the purpose of illustrating the invention, there is shown in the drawings exemplary embodiments of various aspects of the invention. The invention is however not limited to the specific disclosed methods and instrumentalities.

FIG. 1 illustrates a general embodiment of this invention where the same user accesses and edits the same file (an embodiment of business data) from multiple locations using different devices (e.g. Tablet, Mac, PC, Smartphone et al.). The type of devices used are unrestricted as in the knowledge of existing state-of-the-art communication, information processing and display technologies.

FIG. 2 illustrates another general embodiment of this invention where multiple end users located at different geographies try and access the same file (an embodiment of business data) simultaneously using different devices (e.g. Tablet, Mac, PC, Smartphone et al.). The type of devices used are unrestricted as in the knowledge of existing state-of-the-art communication, information processing and display technologies.

FIG. 3 illustrates another general embodiment of this invention where multiple end users from different business units (an embodiment of multiple user groups) located at different geographies try accessing and editing the same file (an embodiment of business data) simultaneously using different devices (e.g. Tablet, Mac, PC, Smartphone et al.). The type of devices used are unrestricted as in the knowledge of existing state-of-the-art communication, information processing and display technologies.

FIG. 4 is a block diagram that illustrates a system architecture where methods outlined in this invention are implemented.

FIG. 5 is a process map diagram that illustrates an embodiment of a file system event profiler in accordance with this invention. This process map diagram is based on a process calculus model for modelling concurrent systems and is designed along the lines of Communicating Sequential Processes (CSP).

FIG. 6 is a process map diagram that illustrates an embodiment of a file download process on the server side in accordance with this invention. This process map diagram is based on a process calculus model for modelling concurrent systems and is designed along the lines of Communicating Sequential Processes (CSP).

FIG. 7 is a process map diagram that illustrates an embodiment of the server side processing undertaken as a subset of the file download process on the server side in accordance with this invention. This process map diagram is based on a process calculus model for modelling concurrent systems and is designed along the lines of Communicating Sequential Processes (CSP).

FIG. 8 is an embodiment of a File System Event Set and a Reduced File System Event Set in accordance with this invention. An exemplification of this embodiment is displayed for the first case study on Microsoft PowerPoint files.

FIG. 9 is an embodiment of a File System Event Set and a Reduced File System Event Set in accordance with this invention. An exemplification of this embodiment is displayed for the second case study on Microsoft Word files.

FIG. 10 is an embodiment of element representation of a File System Event Set and a Reduced File System Event Set in accordance with this invention.

FIG. 11A is a process flow diagram that illustrates the method of handling a file create event on the client side in accordance with this invention.

FIG. 11B is a process flow diagram that illustrates the method of handling a file create operation on the server side in accordance with this invention.

FIG. 12A is a process flow diagram that illustrates the method of handling a file size change event on the client side in accordance with this invention.

FIG. 12B is a process flow diagram that illustrates the method of handling a file modify operation on the server side in accordance with this invention.

FIG. 13A is a process flow diagram that illustrates the method of handling a file rename event on the client side in accordance with this invention.

FIG. 13B is a process flow diagram that illustrates the method of handling a file rename operation on the server side in accordance with this invention.

FIG. 14A is a process flow diagram that illustrates the method of handling a file delete operation on the client side in accordance with this invention.

FIG. 14B is a process flow diagram that illustrates the method of handling a file delete event on the server side in accordance with this invention.

FIG. 15A is a process flow diagram that illustrates the method of handling a file edit event on the client side in accordance with this invention.

FIG. 16A is a process flow diagram that illustrates the method of handling a folder create event on the client side in accordance with this invention.

FIG. 16B is a process flow diagram that illustrates the method of handling a folder create operation on the server side in accordance with this invention.

FIG. 17A is a process flow diagram that illustrates the method of handling a folder rename on the client side in accordance with this invention.

FIG. 17B is a process flow diagram that illustrates the method of handling a folder rename operation on the server side in accordance with this invention.

### SECTION 5.0 DETAILED DESCRIPTION OF THE INVENTION

### Section 5.1 Introduction

The subject matter of this present invention is described with specificity to highlight the resolution of technical challenges faced in realizing general embodiments of file sharing and synchronization for business data. The description itself is not intended to limit the scope of this patent. The inventors have contemplated that the claimed subject matter might also be embodied in other ways, to include different steps or combinations of steps similar to the ones described in this document, in conjunction with other present or future technologies.

### Section 5.2 Deploying Environment

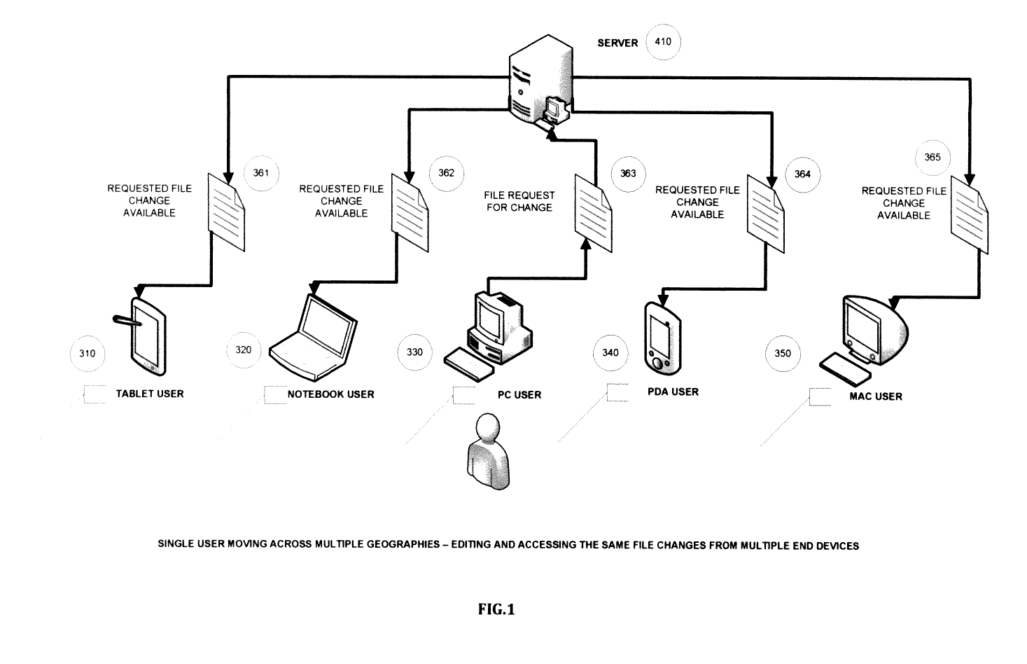

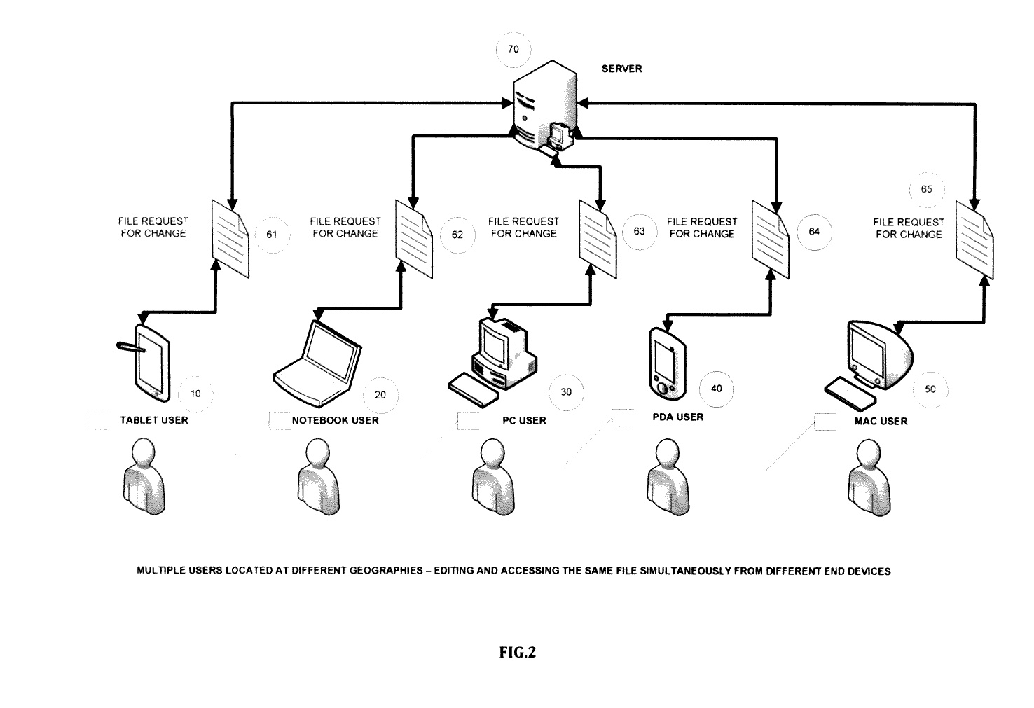

As shown in FIG. 1, the same end user moving across multiple geographies accesses and edits the same file (an embodiment of business data) from multiple locations using different devices (e.g. Tablet, Mac, PC, Smartphone et al.). The type of devices used in the case are unrestricted as in the knowledge of existing state-of-the-art communication, information processing and display technologies.

An end user creates a file X using a Tablet 310 that communicates directly with a Server 410 via a private or public network The file X can be of any type embodying business data (e.g. Microsoft Excel, Microsoft Word, Microsoft PowerPoint et al.). The Tablet 310 can be of any vendor model and the Server 410 can be of any server type (e.g. Windows Server 2008 R2, Oracle Database 12C et al.). Once the user has created a first version of the file X and uploaded onto the Server 410, he edits this file X using his Tablet 310. The changed version 361 of File X, Xi, is communicated to Server 410 and stored there. The user then moves to a different geographical location (e.g. a different section of the same office, a different suburb, a different town, a different country and/or a different intercontinental location) and uses a Notebook 320 to communicate with Server 410 for accessing X₁. Upon accessing X₁, the user edits this file again and the changed version 362 of File X₁, X₂, is communicated to Server 410 and stored there. The user then keeps moving to consecutive other geographical locations and repeats the prior mentioned steps using a PC 330, PDA 340 and Mac 350. The version of the same file X₂ keeps on changing accordingly through versions 363, 364 and 365. In each location, using a different device, the end user is successfully able to access his changed file correctly, edit it and upload it to Server 410. This step is independent of the number of devices in question as well as the type of device used.

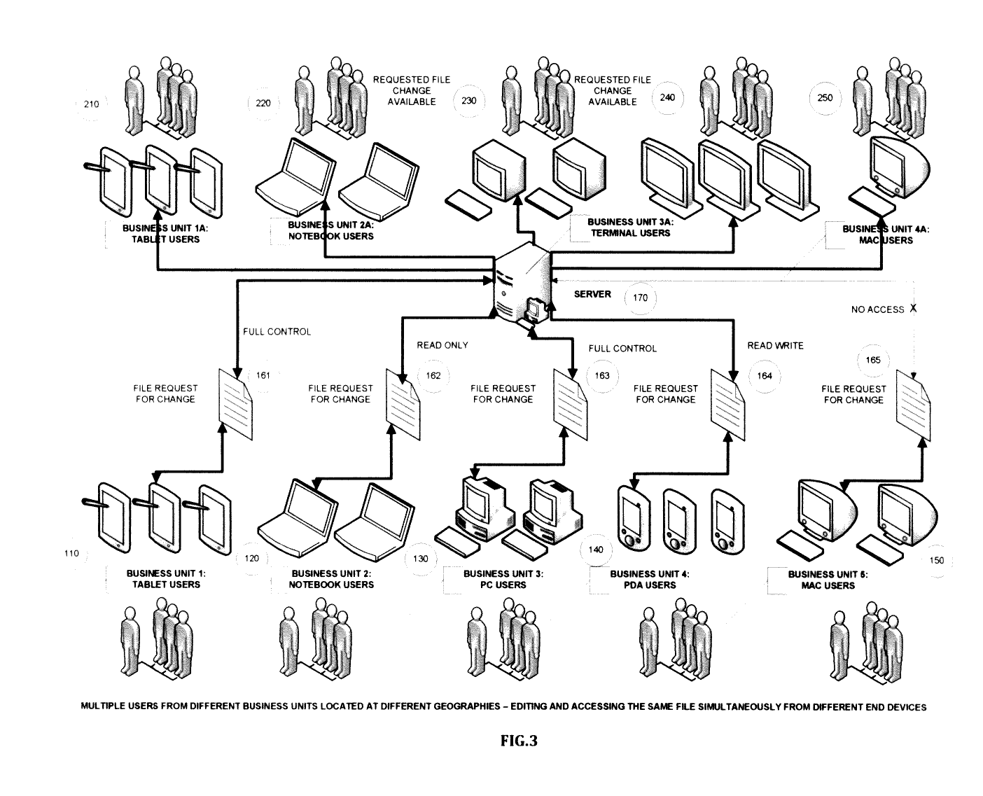

As shown in FIG. 2, multiple end users located at different geographies try and access the same file (an embodiment of business data) simultaneously using different devices (e.g. Tablet, Mac, PC, Smartphone et al.). The type of devices used in this case are unrestricted as in the knowledge of existing state-of-the-art communication, information processing and display technologies.

An end user creates a file X using a Tablet 10 that communicates directly with a Server 70 via a private or public network The file X can be of any type embodying business data (e.g. Microsoft Excel, Microsoft Word, Microsoft PowerPoint et al.). The Tablet 10 can be of any vendor model and the Server 70 can be of any server type (e.g. Windows Server 2008 R2, Oracle Database 12C et al.). Once the user has created a first version of the file X and uploaded onto the Server 70, he edits this file X using his Tablet 10. The changed version 61 of File X, X₁, is communicated to Server 70 and stored there. At the same time, end users located at different geographies try and access the same file Xi using different devices—a Notebook 20, a PC 30, a PDA 40 and a Mac 50. Each end user accesses File X₁ and edit it simultaneously creating multiple versions 62, 63, 64 and 65. The changed versions are stored in the Server 70 and all the changed content created through versions 62, 63, 64 and 65 of X₁ are instantly visible and accessible to each end user using different devices—a Tablet 10, a Notebook 20, a PC 30, a PDA 40 and a Mac 50. The Server 70 stores the final changed version of X₁ after the last end user has finished editing it. This invention enables conflict resolution when the same file name is created by multiple users. This invention further enables simultaneous edit of a single file by multiple end users located at different geographies using different devices by working around the file share access violation problem.

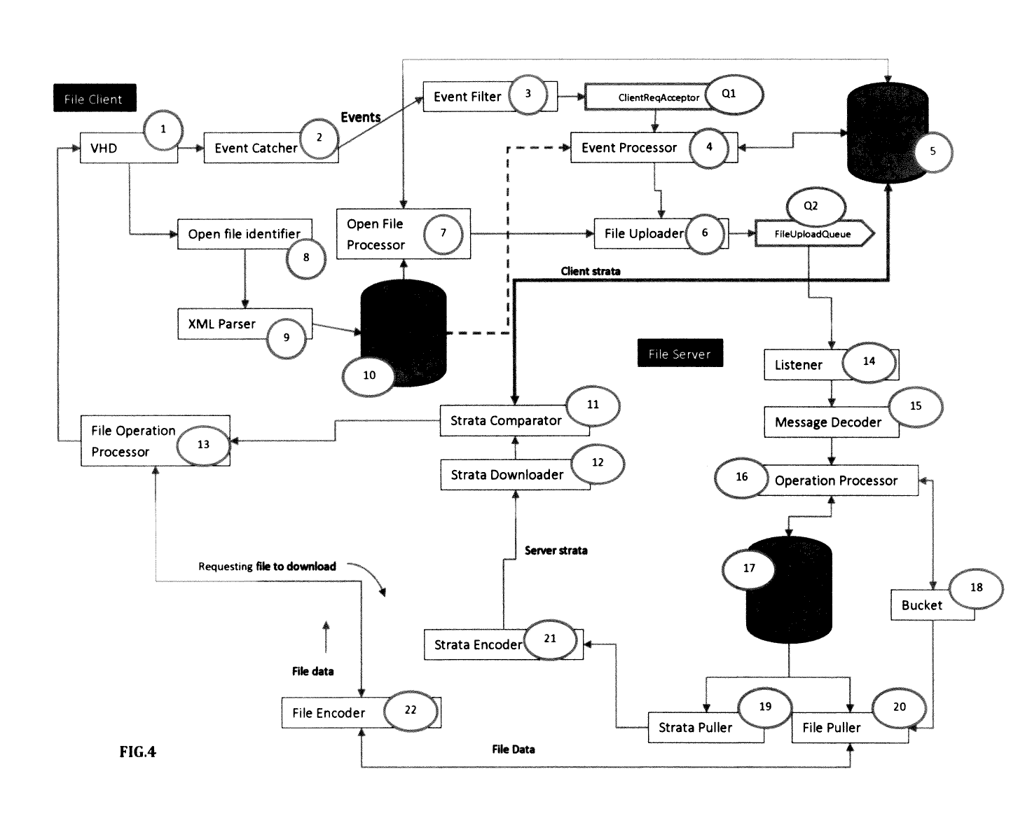

As shown in FIG. 3, multiple end users from different business units (an embodiment of multiple user groups) located at different geographies try accessing and editing the same file (an embodiment of business data) simultaneously using different devices (e.g. Tablet, Mac, PC, Smartphone et al.). The type of devices used are unrestricted as in the knowledge of existing state-of-the-art communication, information processing and display technologies.

A group of end users create a file X using a set of Tablets 110 that communicates directly with a Server 170 via a private or public network. The file X can be of any type embodying business data (e.g. Microsoft Excel, Microsoft Word, Microsoft PowerPoint et al.). The Tablets 110 can be of any vendor model and the Server 170 can be of any server type (e.g. Windows Server 2008 R2, Oracle Database 12C et al.). Once the user group has created a first version of the file X and uploaded onto the Server 170, they edit this file X using Tablets 110. The changed version 161 of File X, X₁, is communicated to Server 170 and stored there. By default File X is always shared within Business Unit 1 so that all users under this group are able to access the same files and work as a team. This invention facilitates an extended share mechanism so that Business Unit 1 can share their workspace with other groups Business Unit 2, Business Unit 3, Business Unit 4 and Business Unit 5. Business 1 can further configure restrictive access while sharing their workspace with other groups to allow them ‘read only’, ‘read write’ or ‘full control’ permissions. This ensures safety of business data and prevents accidental data deletion by other groups. As shown in FIG. 3, Business Unit 1 has full access to File X as an owner. Business Unit 2 has read only access, Business Unit 3 has full control, and Business Unit 4 has read write access while Business Unit 5 has no access to File X. Upon the changed version 161 of File X, X₁, being communicated to Server 170 and stored there, end user groups located at different geographies try and access the same file X₁ using different devices—a set of Notebooks 120, a set of PCs 130, a set of PDAs 140 and a set of Macs 150. Each end user group accesses File X₁ and edit it simultaneously creating multiple versions 162, 163, 164 and 165. The changed versions are stored in the Server 170 and all the changed content created through versions 162, 163, 164 and 165 of X₁ are instantly visible and accessible to each end user group located at different geographies using different devices—a set of Tablets 210, a set of Notebooks 220, a set of PCs 230, a set of PDAs 240 and a set of Macs 250, subject to the permissions allocated by Business Unit 1. The Server 170 stores the final changed version of X₁ after the last end user has finished editing it This invention enables simultaneous edit of a single file by multiple end user groups located at different geographies using different devices by working around the file share access violation problem. This invention further enables permission-governed simultaneous access of the in-situ edited file to multiple end user groups located at different geographies.

### Section 5.3 System Architecture

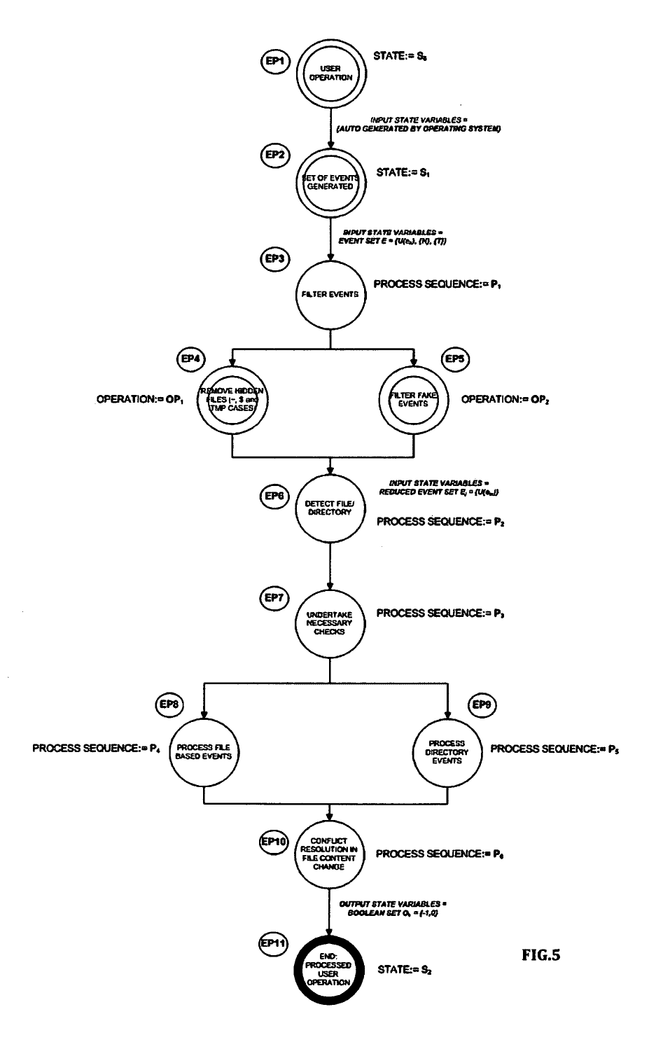

As shown in FIG. 4, an embodiment of this invention's methods can be realized through a system architecture comprising a client-server computing model as an embodiment of virtualization. This is by no means limiting and exhaustive to the scope of this invention and there may be other embodiments of architecture topologies where this invention's methods are applicable (e.g. large scale parallel grid architecture topologies comprising multiple client-server sets).

Virtual Hard Disk (VHD) 1 is an embodiment of software emulation of a physical hard disk drive. An embodiment of a VHD on a host machine allows software emulation of multiple operating systems and physical hardware. This embodiment enables easy communication with remote servers, data backup, recovery and multi-user isolation. File system events are automatically generated during a particular user operation instruction on the VHD (e.g. file create, file rename et al.). The VHD has a unidirectional out-link with Event Catcher 2 and unidirectional out-link with Open File Identifier 8.

Event Catcher 2 is the unit where the automatically generated file system events are collected and sorted for the large number of incoming events. Event Catcher has a unidirectional in-link with VHD 1 and a unidirectional out-link with Event Filter 3. Event Filter 3 is the unit where the sorted file system events are filtered for hidden and temporary files. This section further implements a local software-based queue, ClientReqAcceptor Q1, for queuing sequenced filtered file system events and providing necessary buffer time to execute event processing to completion. This ensures that operations take place in the sequence they occur and no event is missed due to a delay in execution. The output of ClientReqAcceptor Q1 has a unidirectional out-link with Event Processor 4.

Event Processor 4 is the unit where the methods described within the scope of this invention are implemented on the client side. The filtered file system events that are placed on ClientReqAcceptor Q1 are identified, matched and processed corresponding to the user operation that was performed on VHD 1. Event Processor has a unidirectional out-link with File Uploader 6, a bidirectional in-out-link with Client Strata 5 and a unidirectional in-link with Open File DB 10.

Client Strata 5 is a database on the File Client side where information related to client side user operations are stored. Client Strata 5 can have any embodiment within current state-of-the-art database design and implementation existing in prior art. In this invention, it is implemented using SQL Lite. Client Strata 5 has a bidirectional in-out-link with Strata Comparator 11, a bidirectional in-out-link with Open File Processor 7 and a bidirectional in-out-link with Event Processor 4.

File Uploader 6 is the unit where events related to file uploading are processed corresponding to the set of user operations (e.g. file create, file rename, file edit et al.). This can be mapped from the versions 61, 62, 63, 64, 65 of FIG. 2. File Uploader 6 has an associated queue, FileUploadQueue Q2, for queuing processed file system events for input to the File Server in first-in-first-out (FIFO) mode ensuring that no event is missed for execution delays. File Uploader 6 has a unidirectional out-link through FileUploadQueue Q2 with Listener 14 on the File Server side.

Open File Processor 7, Open File Identifier 8, XML Parser 9 and Open File DB 10 are relevant only to “file open” events and is implemented in this invention using OpenedFilesView v1.52, a third-party freeware available in the open source domain.

Open File Identifier 8 is the unit that processes a file open event once a corresponding user operation on VHD 1 is executed. This unit keeps on listening to and waits for a “file open” event from the VHD. Upon processing the “file open” event, this unit converts the file system event to a XML string. Open File Identifier 8 has a unidirectional in-link with VHD 1 and a unidirectional out-link with XML Parser 9.

XML Parser 9 is the unit that parses the XML string generated from Open File Identifier 8. XML Parser 9 has a unidirectional in-link with Open File Identifier 8 and a unidirectional out-link with Open File DB 10.

Open File DB 10 is a database on the File Client side where the parsed XML data associated with a “file open” event is stored. Open File DB 10 can have any embodiment within current state-of-the-art database design and implementation existing in prior art. In this invention, it is implemented using SQLite. SQLite is a software library that implements a self-contained, server-less and transactional SQL database engine that can easily work with on limited computing resources. Open File DB 10 has a unidirectional in-link with XML Parser 9 and a unidirectional out-link with Open File Processor 7.

Open File Processor 7 is the unit that generates threads per processed “file open” event sourced in XML format from Open File DB 10. Open File Processor 7 constantly listens from Open File DB 10 for the occurrence of a “file open” event and upon detection, generates a corresponding thread that remains associated with that file till its lifetime (e.g. till the file is closed and a “file closed” event is generated by the corresponding user operation on VHD 1). This is then communicated with File Uploader 6 for linking with the Listener on the File Server side. Open File Processor 7 has a unidirectional in-link with Open File DB 10, a unidirectional out-link with File Uploader 6 and a bidirectional in-out-link with Client Strata 5.

Strata Comparator 11 is the unit where current records for client strata are compared. Based on the strata comparison that takes place at State Comparator 11, a decision can be made about the state of the client being in sync or out-of-sync. If all the files/folders are out of sync, Strata Comparator 11 may take a decision of downloading missing files or uploading newly created files to the server. Strata Comparator 11 is also responsible for ensuring that Client Strata 5 is sync-ed with the latest changes. The final decision flow is passed to File Operation Processor 13. Strata Comparator 11 has a bidirectional in-out-link with Client Strata 5, a unidirectional out-link with File Operation Processor 13 and a unidirectional in-link with Strata Downloader 12.

Strata Downloader 12 is the unit that retrieves records for user operation generated file system events from the File Server side. Strata Downloader has a unidirectional in-link with Strata Encoder 21 and a unidirectional out-link with Strata Downloader 12.

File Operation Processor 13 is the unit that processes and maps file system event data back to corresponding user operations. It receives corresponding records for user operation generated file system events from Strata Comparator 11 to match the user operations while performing the reverse mapping. Based on the information provided by Strata Comparator 11, File Operation Processor 13 can request File Encoder 22 to download a file that is not present or modified on VHD 1. File Operation Processor 13 has a unidirectional out-link with VHD 1, a unidirectional in-link with File Encoder 22 and a unidirectional in-link with Strata Comparator 11.

Listener 14 is the unit that listens for an event generated by placing a request on FileUploadQueue Q2 of File Uploader 6. The main function of this unit is to listen and clear the FileUploadQueue as soon as a request is placed on it by File Uploader 6. Listener 14 has a unidirectional in-link with File Uploader 6 through FileUploadQueue Q2 and a unidirectional out-link with Message Decoder 15.

Message Decoder 15 is the unit that decodes the processed file system events of the corresponding user operations involving the server side. Message Decoder 15 has a unidirectional in-link with Listener 14 and a unidirectional out-link with Operation Processor 16.

Operation Processor 16 is the unit where the methods described within the scope of this invention are implemented on the server side. The decoded file system events of the corresponding user operations link with Server Strata 17 and the files pushed into a Bucket 18. Operation Processor has a unidirectional in-link from Message Decoder 15, a bidirectional in-out-link with Server Strata 17 and a bidirectional in-out-link with Bucket 18.

Server Strata 17 is a database on the File Server side where information related to server side user operations are stored. Server Strata 17 can have any embodiment within current state-of-the-art database design and implementation existing in prior art. In this invention, it is implemented using SQL Lite. Server Strata 17 has a bidirectional in-out-link with Operation Processor 16, a unidirectional out-link with Strata Puller 19 and a unidirectional out-link with File Puller 20.

Bucket 18 is the unit where files are stored, including large files that are shared and synchronized between multiple end users as shown in embodiments of FIG. 1, FIG. 2 and FIG. 3. Bucket 18 has been implemented using third-party software Solid File System (SolFS), a proprietary product of EldoS Corporation. SolFS implements additional features such as on-the-fly compression for storage, thread serialization for maintaining data integrity et al. This implementation enables server storage space savings with easy maintenance. Bucket 18 has a bidirectional in-out-link with Operation Processor 16 and a unidirectional out-link with File Puller 20.

Strata Puller 19 is the unit that retrieves the file system event records from Server Strata 17. Strata Puller 19 is a separate entity that is dedicated to extract file records from Server Strata 17 and provide those records to Strata Encoder 21 to communicate with client software. Strata Puller 19 has a unidirectional in-link with Server Strata 17 and a unidirectional out-link with Strata Encoder 21.

File Puller 20 is the unit that retrieves the file system events from Server Strata and the corresponding files from Bucket 18. File Puller 20 has a unidirectional in-link with Server Strata 17, a unidirectional in-link with Bucket 18 and a unidirectional out-link with File Encoder 22.

Strata Encoder 21 is the unit that encodes the file system event records retrieved from Strata Puller 19 to create corresponding server strata records. Strata Encoder has a unidirectional in-link with Strata Puller 19 and a unidirectional out-link with Strata Downloader 12.

File Encoder 22 is the unit that processes files for download after corresponding strata record matching and file system event record retrieval has been performed correctly. These processed files are then sent to File Operation Processor 13 for mapping back to user operations on VHD 1. File Encoder 22 has a unidirectional in-link with File Puller 20 and a bidirectional in-out-link with File Operation Processor 13.

### Section 5.4 Inventive Method of a File System Event Profiler

As shown in FIG. 5, an embodiment of a file system event profiler's inventive method is illustrated through a process map in accordance with this invention. This process map diagram is based on a process calculus model for modelling concurrent systems and is designed along the lines of Communicating Sequential Processes (CSP).

The method of a file system event profiler in accordance with this invention is implemented in Event Catcher 2, Event Filter 3, Event Processor 4 and File Uploader 6 illustrated in FIG. 4.

As shown in FIG. 5, execution of the user operation EP1 in VHD 1 (vide FIG. 4) drives the state of the file system event to S₀. The input state variables to S₀ are automatically generated EP2 by the operating system in VHD 1. This drives the state of the file system event to S₁ in Event Catcher 2 where an Event Set E={U(eₖ), {H}, {T}} is generated.

Event Set E={U(eₖ), {H}, {T}} comprises of individual file system events eₖ, Hidden Files {H} and Temporary Files {T}.

In Event Filter 3 (vide FIG. 4), Event Set E is filtered EP3 of the Hidden Files (H) and Temporary Files (T) EP4 through Operation OP₁. Regardless of the individual file system event types associated with hidden and temporary files, all of them are filtered out in this unit by identifying ‘$’, ‘˜’ at the beginning of file names and .TMP and .tmp file name extensions at the end. Fake events are detected and filtered EP5 through Operation OP₂. After filtering, the original Event Set E gets transformed into the Reduced Event Set Eⱼ={U(eₘ)}, that comprises individual file system events eₘ. The transformed individual file system events eₘ are placed on ClientReqAcceptor Q1.

In Event Processor 4 (vide FIG. 4), from the Reduced Event Set, detection of the difference between a file and a directory is first done in EP6. Necessary checks are performed in EP7 to ensure consistency of the event set and the file/directory structure.

Depending on the file/directory identification, file and directory events are processed EP8, EP9 in Event Processor 4 (vide FIG. 4).

There is a separate process sequence P₆ that enables conflict resolution in file content change EP10. This occurs in Event Processor 4 (vide FIG. 4).

After the set of process sequences are executed, the user operation is processed correctly EP11 involving the corresponding file system events. Upon success of the microcode execution, the output state variable returns −1 (in case of failure) or 0 (in case of success). This drives the state of the file system event to S₂.

### Section 5.5 Inventive Method of File Download Process and Associated Server Side Processing

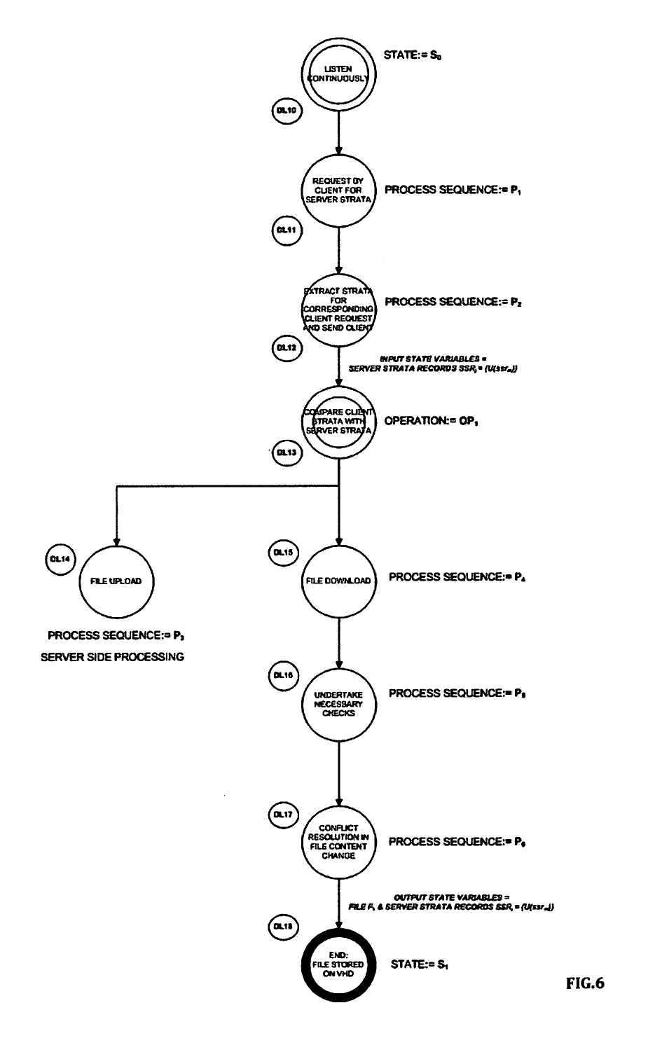

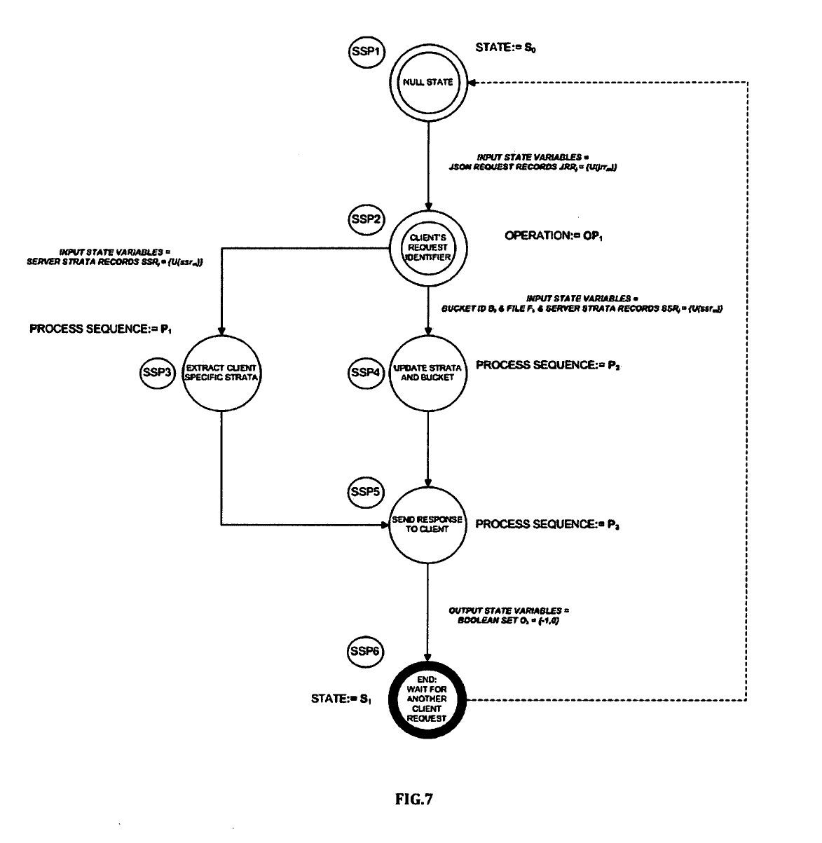

As shown in FIG. 6, an embodiment of the file download process and the associated server side processing's inventive method is illustrated through a process map in accordance with this invention. This process map diagram is based on a process calculus model for modelling concurrent systems and is designed along the lines of Communicating Sequential Processes (CSP). Within the File Upload unit shown as part of the file download process in FIG. 6, the Server Side Process Sequence (as shown in FIG. 7) is executed.

The method of the file download process and associated server side processing in accordance with this invention is implemented in Server Strata 17, Bucket 18, Strata Puller 19, File Puller 20, Strata Encoder 21, File Encoder 22, Strata Downloader 12 and File Operation Processor 13 as illustrated in FIG. 4.

The File Server state initially So is that of Listening for a processed file system event from the Reduced Event Set Eⱼ as described in Section 1.4 of this invention. The Listener 14 (vide FIG. 4) listens in the idle state DL10 for a continuous time window.

The initial state SSP1 is a null state S₀ that resides in listening mode. The input state variables to this state are JSON request records JRR₁={U(jrrₘ)} that comprise client side request identifiers from corresponding user operations generated on VHD 1 (vide FIG. 4). The Strata Downloader 12 requests the server using JSON messages for recently updated strata during execution DL11 of process sequence P₁.

The requests are sent to Strata Encoder 21 that pulls the current strata entries from Server Strata 17 corresponding to the Bucket ID Bₖ through Strata Puller 19. After the successful communication of the requests, process sequence P₂ is executed DL12.

Through the process sequence P₂, the input state variable set of the server strata records SSRⱼ={U(ssrₘ)} is executed DL13 and the strata is sent to Strata Downloader 12 and on to Strata Comparator 11. During execution of operation OP1, the server strata records SSRⱼ are compared with client strata extracted from Client Strata 5 by Strata Comparator 11. Based on the outcome of this comparison, a decision is sent to File Operation Processor 13 (e.g. File Download) that executes DL15 of process sequence P₄. The File Download request, following the execution of P₄, is sent to File Encoder 22 that extracts an appropriate File ID Fₖ through File Puller 20. Upon the successful extraction of the file associated with File ID Fₖ, data is transmitted back to File Operation Processor 13. The File Operation Processor undertakes necessary checks (execution DL16 of process sequence P₅) and performs conflict resolution in file content change (execution DL17 of process sequence P₆) on VHD 1 before proceeding to store files on VHD 1. The output state variables are File ID Fₖ & Server Strata Records SSRⱼ={U(ssrₘ)}. This drives the state of the file system event to S₁.

As shown in FIG. 7, an embodiment of the server side processing undertaken as a subset of the file download process is implemented in accordance with this invention. This process map diagram is based on a process calculus model for modelling concurrent systems and is designed along the lines of Communicating Sequential Processes (CSP).

For instruction DL14 (vide FIG. 7), the process sequence P₃ is executed as part of the File Download. The initial state SSP1 is a null state S₀ that resides in listening mode. The input state variables to this state are JSON request records JRRⱼ={U(jrrₘ)} that comprise client side request identifiers from corresponding user operations generated on VHD 1 (vide FIG. 4).

Operation OP₁, acting on Client's Request Identifier SSP2 generates two further input state variables: a) Server Strata Records SSRⱼ={U(ssrₘ)}; b) Bucket ID Bₖ & File ID Fₖ & Server Strata Records SSRⱼ={U(ssrₘ)}.

For the input state variables as Server Strata Records SSRⱼ={U(ssrₘ)} only, Process Sequence P₁ executes to extract client specific strata SSP3 that is sent SSP5 to the client by executing Process Sequence P₃. After this is executed the second state S₁ is reached that again drives to the listening mode, waiting for another client request for identifiers of corresponding user operations. State S₁ degenerates to the initial null state S₀ after a set timeout window.

For the input state variables as Bucket ID Bₖ & File ID Fₖ & Server Strata Records SSRⱼ={U(ssrₘ)}, Process Sequence P₂ executes to update SSP4 Server Strata 17 and Bucket 18 (vide FIG. 4). After this update, Process Sequence P₃ executes to send the response SSP5 to the client. After this is executed the second state S₁ is reached that again drives to the listening mode, waiting for another client request for identifiers of corresponding user operations. State S₁ degenerates to the initial null state S₀ after a set timeout window.

### Section 5.6 Methods of Handling File System Events

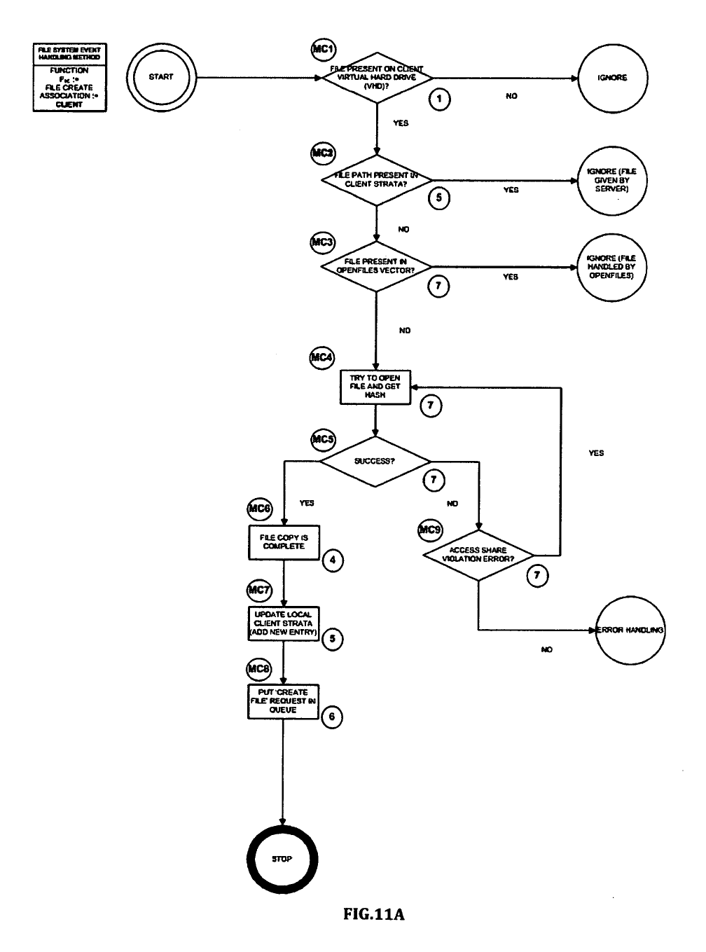

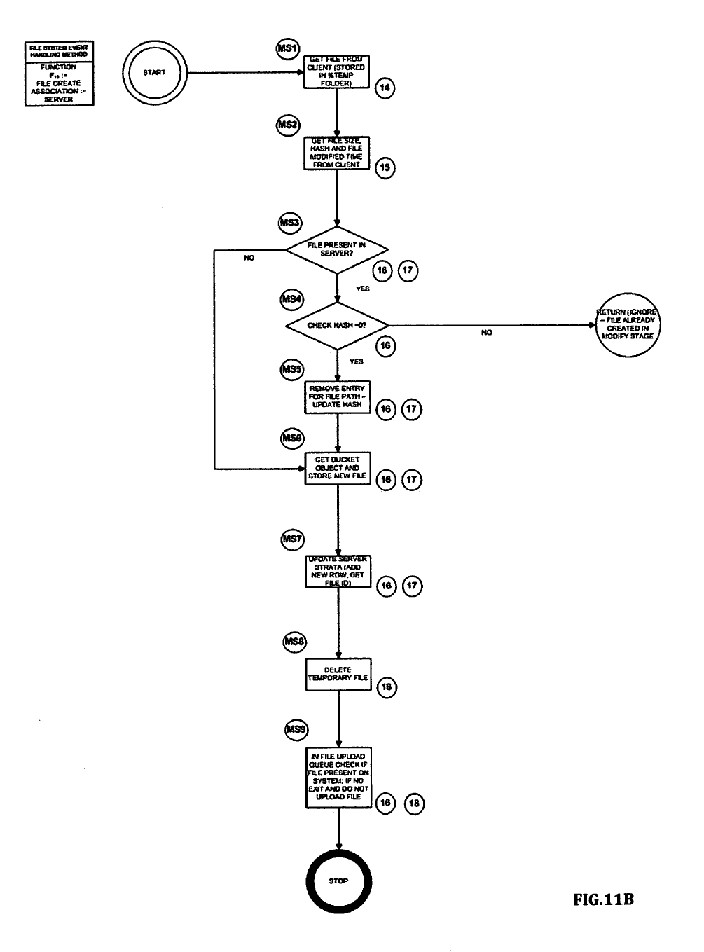

FIG. 11A illustrates the method of handling a file create event on the client side in accordance with this invention.

The embodiment of the method of handling a file create event associated with the client side is a Function F_{1C} that comprises a sequence of method steps as shown in FIG. 11A. Function F_{1C} corresponds to User Operation “File Create” that is executed on Virtual Hard Drive VHD 1 (vide FIG. 4).

Function F_{1C} operates on Reduced Event Sets Eⱼ={U(eₘ)}, that comprises individual file system events eₘ, in Event Processor 4 of the File Client Side (vide FIG. 4). A further Reduced Event Set Eᵢ={U(eₙ)} is generated after Function F_{1C} operates on Eⱼ. In Communicating Sequential Processes (CSP) notation this can be expressed as F_{1C}(Eⱼ)=Eᵢ [symbol] F_{1C}({U(eₘ)})={U(eₙ)}, where 0<n≦m.

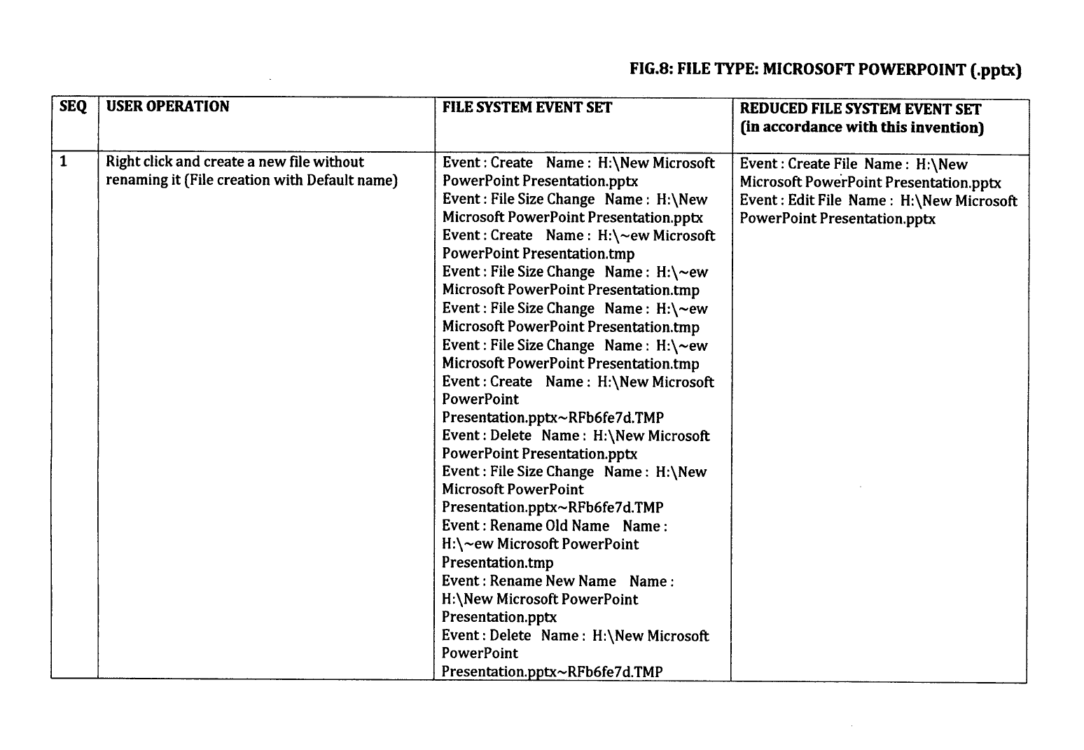

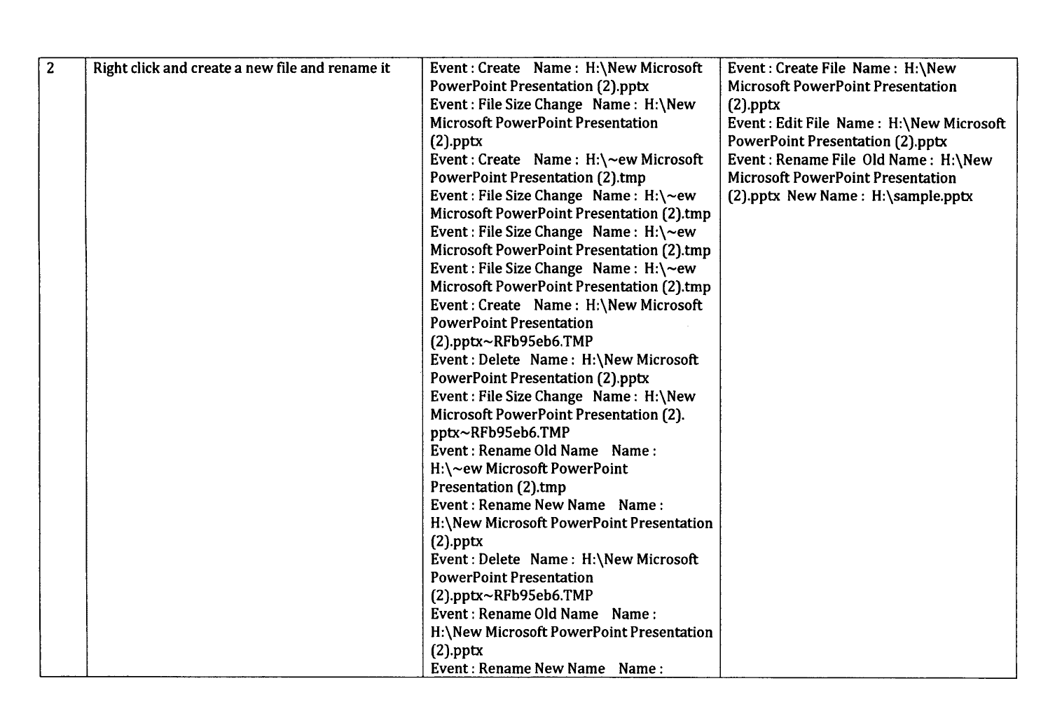

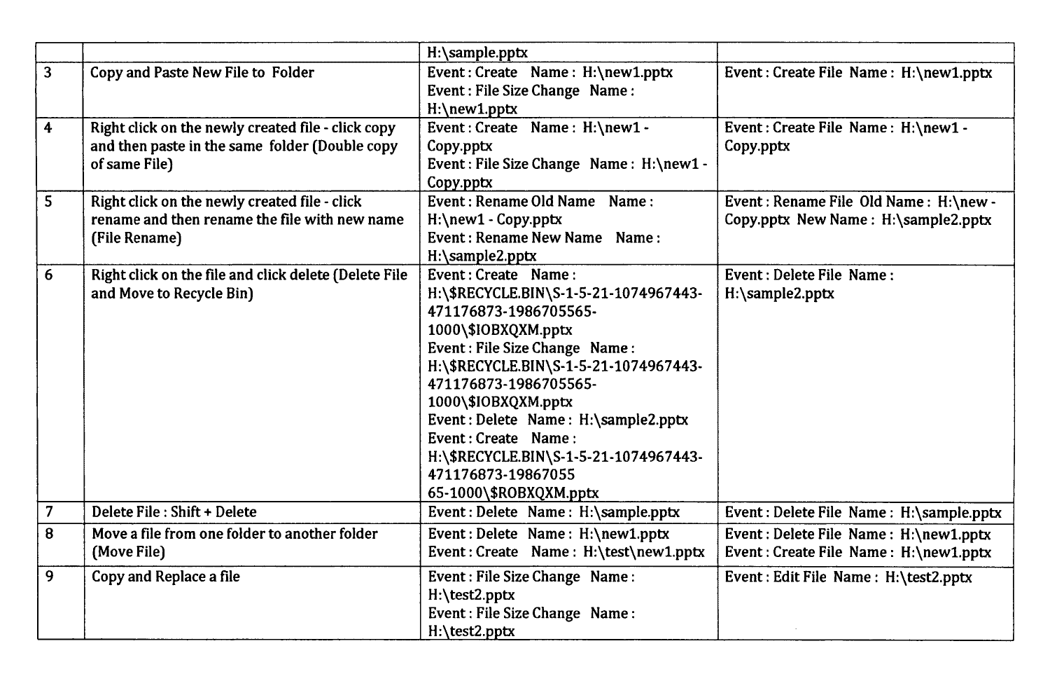

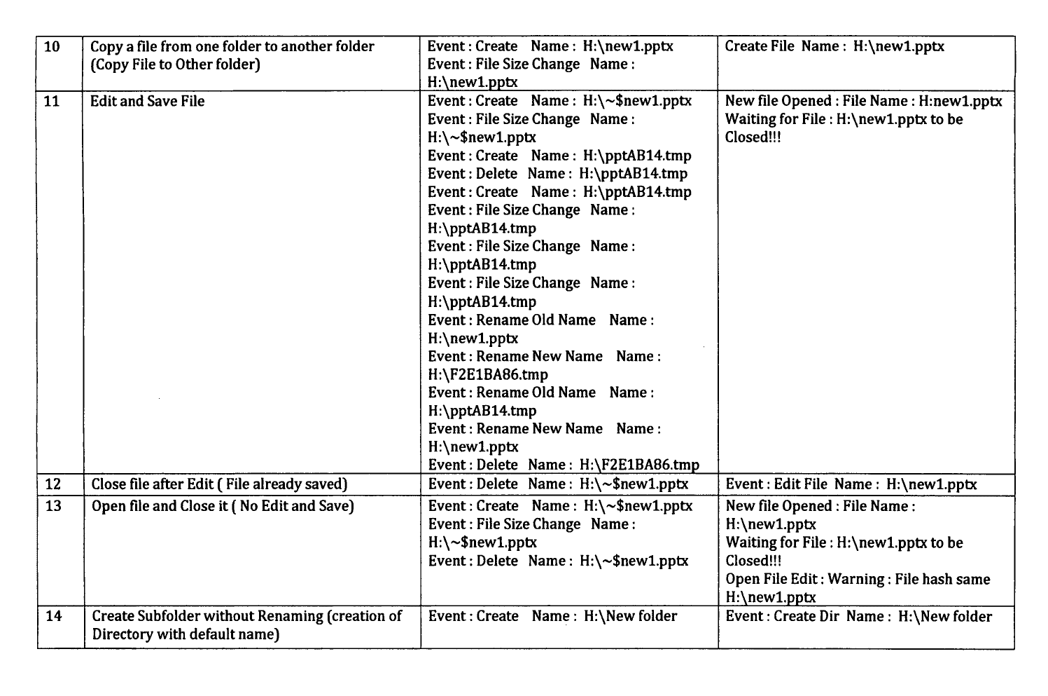

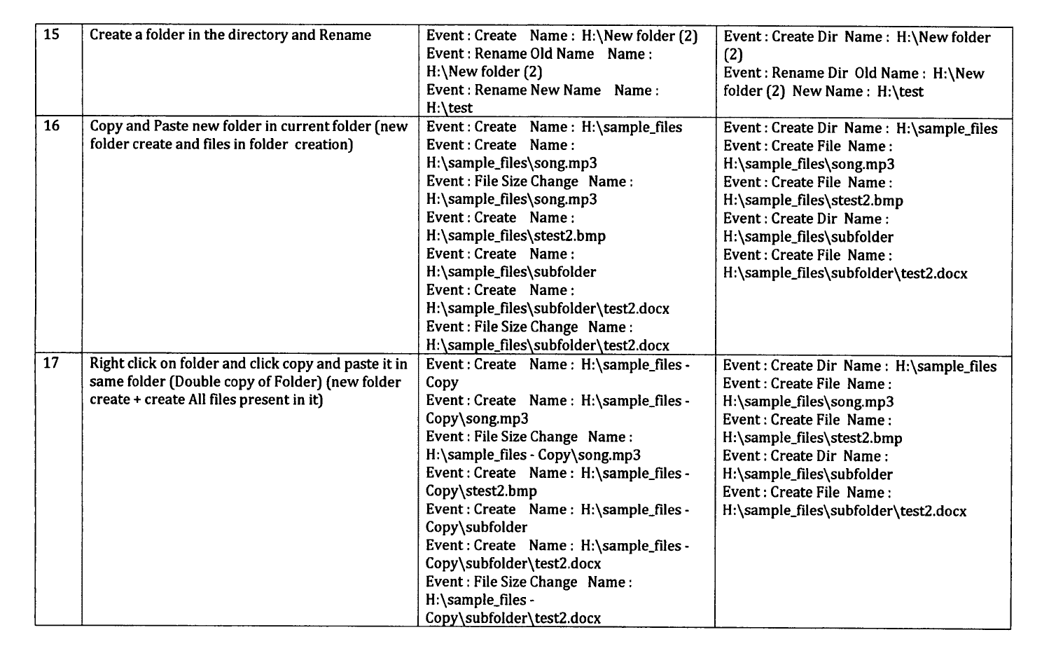

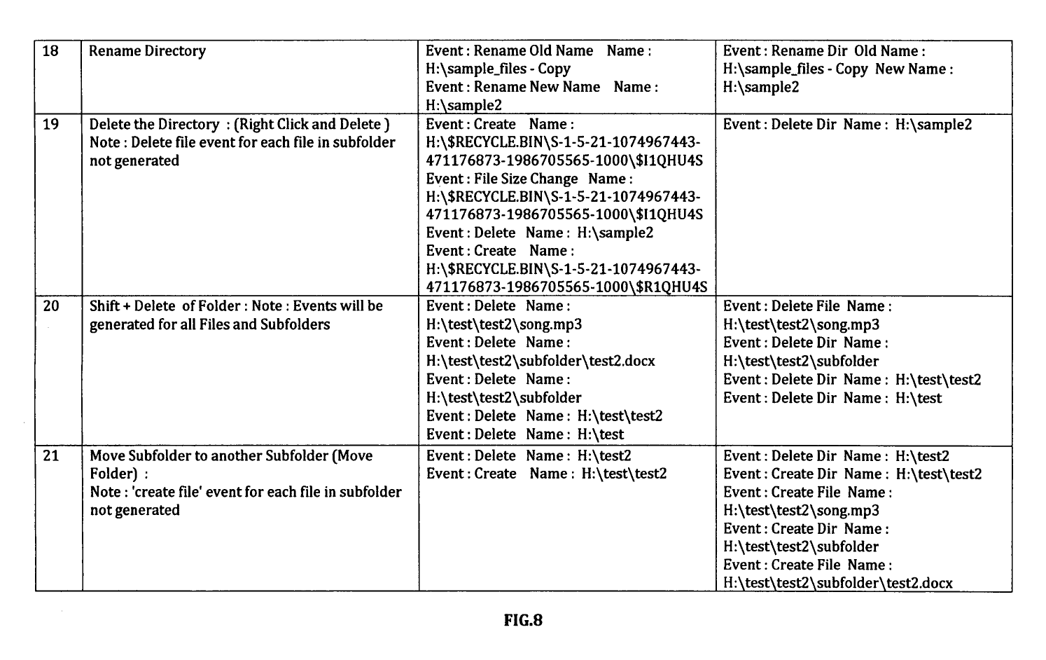

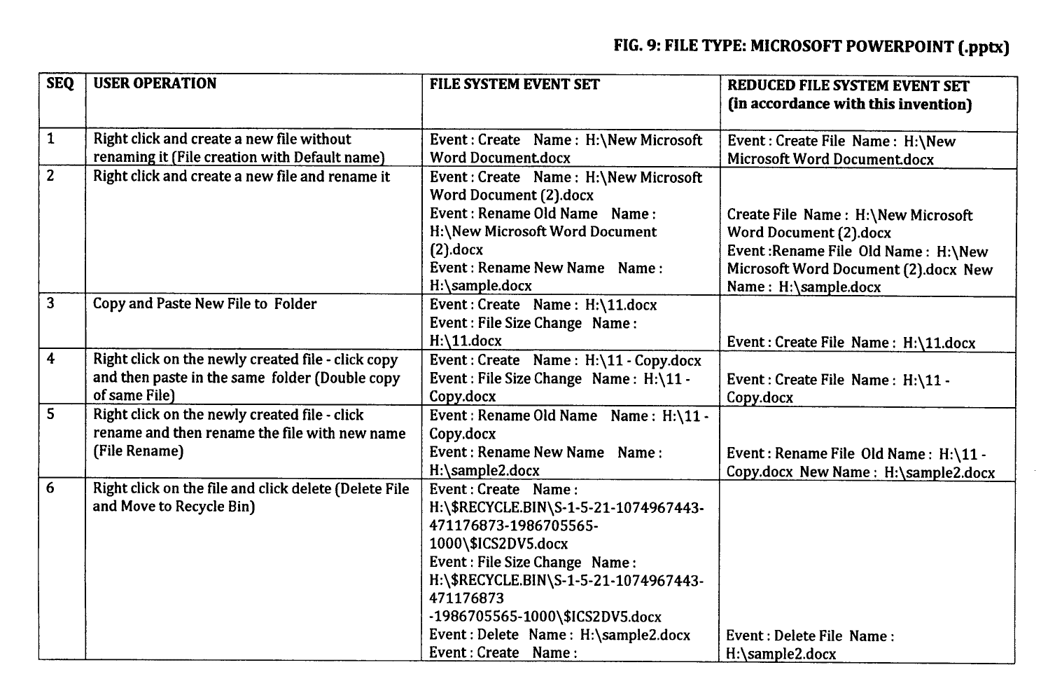

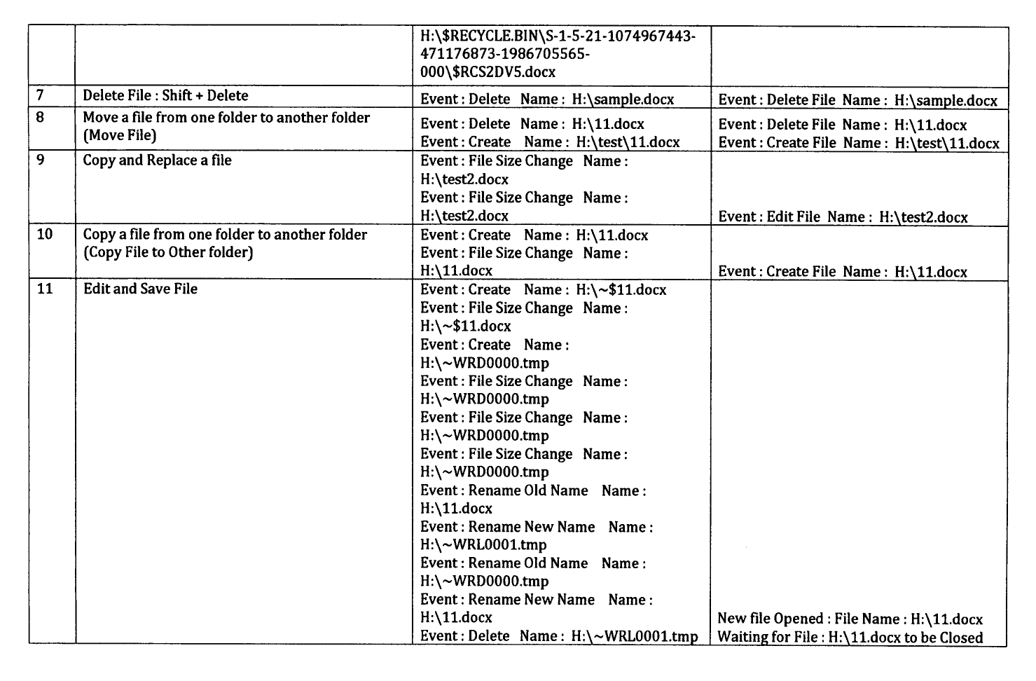

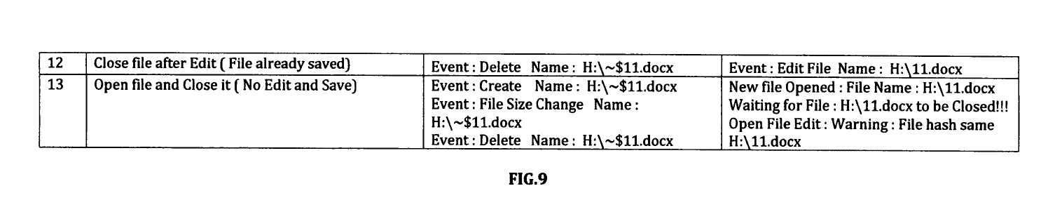

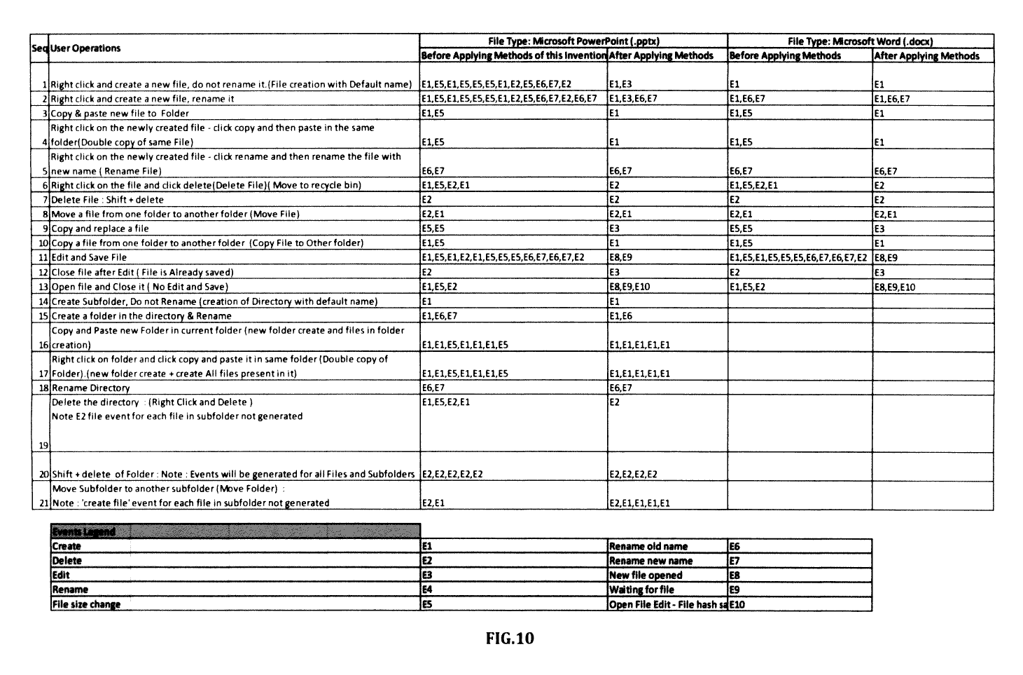

The embodiment of this Communicating Sequential Process-generated further Reduced Event Set Eᵢ is illustrated in FIG. 8, FIG. 9 and FIG. 10 as exemplifications through Microsoft PowerPoint and Microsoft Word files in accordance with this invention. The element representation of the further Reduced Event Set Eᵢ is shown in FIG. 10 in accordance with this invention.

Step 1 of the method MC1 is to determine whether the file exists on the VHD 1 (vide FIG. 4) for the user operation “File Create”. Upon a Yes, the flow passes on to MC2. Upon a No, the User Operation is ignored, as a new file that already exists on VHD 1 cannot be created again. Step 1 is executed on VHD 1 (vide FIG. 4).

Step 2 of the method MC2 is to determine whether the file path is present in client strata. Upon a No, the flow passes on to MC3. Upon a Yes, the User Operation is ignored, as the Server provides the instance of the file path. Step 2 is executed on Client Strata 5 (vide FIG. 4).

Step 3 of the method MC3 is to determine whether the file is present in the Open Files vector of OpenedFilesView v1.52. Upon a No, the flow passes on to MC4. Upon a Yes, the User Operation is ignored, as the file is handled by OpenedFilesView v1.52. Step 3 is executed on Open File Processor 7 (vide FIG. 4).

Step 4 of the method MC4 is to try and open the file and extract a hash associated with the file. Step 4 is executed on Open File Processor 7 (vide FIG. 4).

Step 5 of the method MC5 tests the success of the file open and associated hash extraction. Upon a Yes, the flow passes on to MC6. Upon a No, the flow passes on to MC9. Step 5 is executed on Open File Processor 7 (vide FIG. 4).

Step 6 of the method MC6 follows the success of opening a file and extracting the hash associated with the file. This step continues on till the file copy is complete. Upon file copy completion, the flow passes on to MC7. Step 6 is executed on Event Processor 4 (vide FIG. 4).

Step 7 of the method MC7 updates the local client strata by adding a new record entry for the created file. Upon this completion, the flow passes on to MC8. Step 7 is executed on Client Strata 5 (vide FIG. 4).

Step 8 of the method MC8 puts the “file create” request on FileUploadQueue Q2 (refer FIG. 4). The flow ends from this step upon success. Step 8 is executed on File Uploader 6 (refer FIG. 4).

Step 9 of the method MC9 determines if there is an access violation error if the file open and hash extraction is unsuccessful. If there is no access violation error, the file is handled through appropriate error handling mechanisms. If there is access violation error, the flow retraces back to MC4, where repeated attempts at trying and opening the file are made along with the corresponding hash extractions. Step 9 is executed on Open File Processor 7 (vide FIG. 4).

FIG. 11B is a process flow diagram that illustrates the method of handling a file create event on the server side in accordance with this invention.

The embodiment of the method of handling a file create event associated with the server side is a Function F_{1S} that comprises a sequence of method steps as shown in FIG. 11B. Function F_{1S} corresponds to User Operation “File Create” that is executed on Virtual Hard Drive VHD 1 (vide FIG. 4).

Step 1 of the method MS1 is retrieving the file from the client which is stored on a temporary folder. Upon successful retrieval of the file, the flow passes on to MS2. Step 1 is executed on Listener 14 (vide FIG. 4).

Step 2 of the method MS2 is extracting the file size, hash and file modified time from the retrieved file. Upon successful extraction of the relevant file parameters, the flow passes on to MS3. Step 2 is executed on Message Decoder 15 (vide FIG. 4).

Step 3 of the method MS3 determines whether the file is present on the server. Upon a Yes, the flow passes on to MS6. Upon a No, the flow passes on to MS4. Step 3 is executed on Operation Processor 16 and Server Strata 17 (vide FIG. 4).

Step 4 of the method MS4 determines if the extracted hash value from the file parameters is zero upon confirmation of the file's presence on the server. Upon a No, the “File Create” User Operation is ignored as the already created file is currently being modified. Upon a Yes, the flow passes on to MS5. Step 4 is executed on Operation Processor 16 (vide FIG. 4).

Step 5 of the method MS5 removes the file path entry upon the determination that the extracted has value from the parameters is zero. The hash value is updated at this step. Upon the hash value update, the flow passes on to MS6. Step 5 is executed on Operation Processor 16 and Server Strata 17 (vide FIG. 4).

Step 6 of the method MS6 fetches the corresponding bucket object and stores the new created file on the server. Upon successful storage of the new created file on the server, the flow passes on to MS7. Step 6 is executed on Operation Processor 16 and Server Strata 17 (vide FIG. 4).

Step 7 of the method MS7 updates the server strata by adding a new row and fetching the stored file identifier. Upon successful server strata update, the flow passes on to MS8. Step 7 is executed on Operation Processor 16 and Server Strata 17 (vide FIG. 4).

Step 8 of the method MS8 deletes temporary files. Upon successful temporary file deletion, the flow passes on to MS9. Step 8 is executed on Operation Processor 16 (vide FIG. 4).

Step 9 of the method MS9 checks the file's presence on FileUploadQueue Q2 (vide FIG. 4). If the presence is null, then the file is not uploaded and the flow ends from this step.

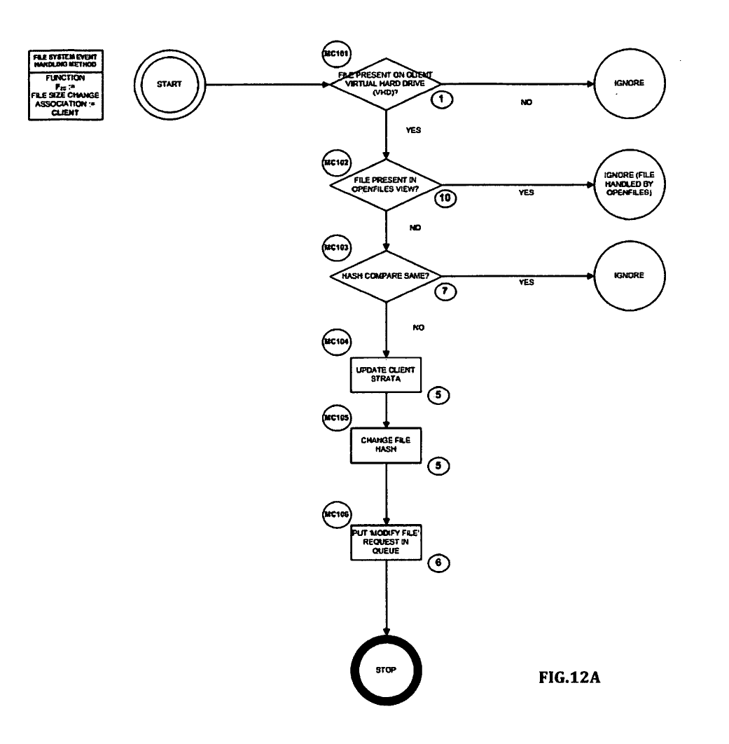

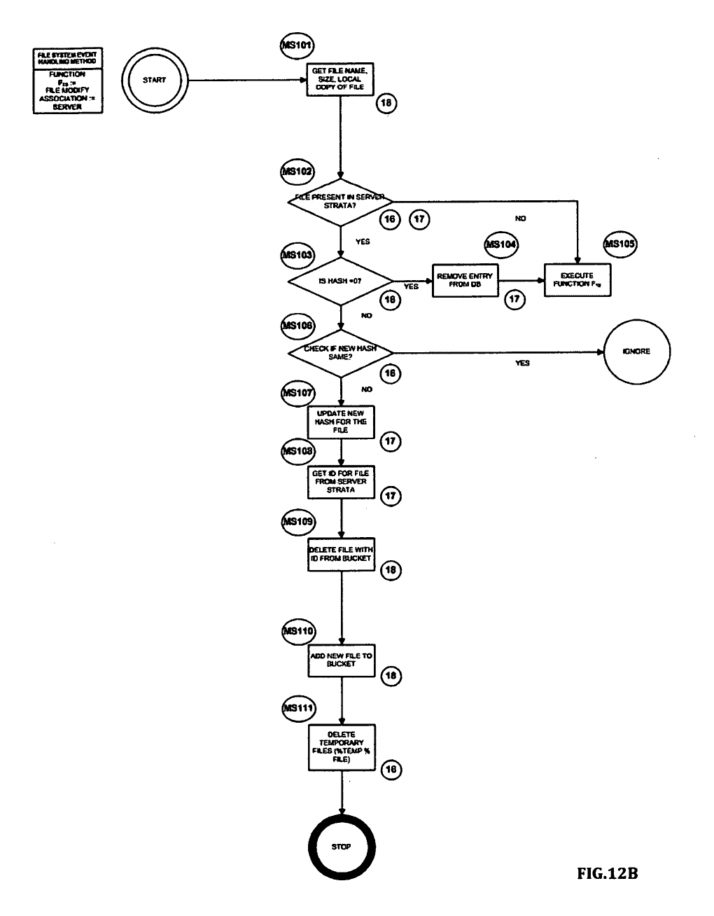

FIG. 12A is a process flow diagram that illustrates the method of handling a file size change event on the client side in accordance with this invention.

The embodiment of the method of handling a file size change event associated with the client side is a Function F_{2C} that comprises a sequence of method steps as shown in FIG. 12A. Function F_{2C} corresponds to User Operation “File Size Change” that is executed on Virtual Hard Drive VHD 1 (vide FIG. 4).

Step 1 of the method MC101 determines if the file is present on the client Virtual Hard Drive VHD 1 (vide FIG. 4). Upon a No, the User Operation is ignored. Upon a Yes, the flow passes on to MC102. Step 1 is executed on VHD 1 (vide FIG. 4).

Step 2 of the method MC102 determines if the file is present in the Open File database of OpenedFilesView v1.52 upon confirmation that the file is present on VHD 1 (vide FIG. 4). Upon a Yes, the User Operation is ignored as the file is handled by OpenedFilesView v1.52. Upon a No, the flow passes on to MC103. Step 2 is executed on Open File DB 10 (vide FIG. 4).

Step 3 of the method MC103 compares the equality of the hash values of the files. Upon a Yes, the User Operation is ignored. Upon a No, the flow passes on to MC104. Step 3 is executed on Open File Processor 7 (vide FIG. 4).

Step 4 of the method MC104 updates the client strata. Upon successful and correct update of the client strata, the flow passes on to MC105. Step 4 is executed on Client Strata 5 (vide FIG. 4).

Step 5 of the method MC105 changes the file hash value. Upon changing the hash value correctly, the flow passes on to MC106. Step 5 is executed on Client Strata 5 (vide FIG. 4).

Step 6 of the method MC106 inserts a ‘file modify’ request on FileUploadQueue Q2 (refer FIG. 4). Step 6 is executed on File Uploader 6 (vide FIG. 4). The flow ends from this step.

FIG. 12B is a process flow diagram that illustrates the method of handling a file modify event on the server side in accordance with this invention.

The embodiment of the method of handling a file modify event associated with the server side is a Function F_{2S} that comprises a sequence of method steps as shown in FIG. 12B. Function F_{2S} corresponds to User Operation “File Modify” that is executed on Virtual Hard Drive VHD 1 (vide FIG. 4).

Step 1 of the method MS101 retrieves the file name, file size and the local copy of the file. Upon the successful retrieval of the file parameters, the flow passes on to MS102. Step 1 is executed on Bucket 18 (vide FIG. 4).

Step 2 of the method MS102 determines if the retrieved file is present on the server strata upon successful retrieval of the file parameters. Upon a No, Function F_{1S} is invoked and the corresponding method steps executed. Upon a Yes, the flow passes on to MS103. Step 2 is executed on Operation Processor 16 and Server Strata 17 (vide FIG. 4).

Step 3 of the method MS103 determines if the hash value of the retrieved file is zero. Upon a Yes, the flow passes on to MS104. Upon a No, the flow passes on to MS106. Step 3 is executed on Operation Processor 16 (vide FIG. 4).

Step 4 of the method MS104 removes the entry from server strata upon determining that the hash value of the retrieved file is zero. Upon deletion, the flow passes on to MS105. Step 4 is executed on Server Strata 17 (vide FIG. 4).

Step 5 of the method MS105 is an exact replica of the method of handling a file create event on the server side in accordance with this invention. Function F_{1S} is invoked and the corresponding method steps executed.

Step 6 of the method MS106 determines if the new hash value of the file is the same as the old one upon confirmation that the retrieved hash value is not zero. Upon a Yes, this User Operation is ignored. Upon a No, the flow passes on to MS107. Step 6 is executed on Operation Processor 16 (vide FIG. 4).

Step 7 of the method MS107 updates the hash value of the new file. Upon successful and correct update, the flow passes on to MS108. Step 7 is executed on Server Strata 17 (vide FIG. 4).

Step 8 of the method MS108 retrieves the file identifier from the server strata. Upon successful and correct retrieval, the flow passes on to MS109. Step 8 is executed on Server Strata 17 (vide FIG. 4).

Step 9 of the method MS109 deletes the file with the corresponding identifier from the bucket. Upon successful deletion, the flow passes on to MS110. Step 9 is executed on Bucket 18 (vide FIG. 4).

Step 10 of the method MS110 adds the modified file with the corresponding identifier to the bucket. Upon successful insertion, the flow passes on to MS111. Step 10 is executed on Bucket 18 (vide FIG. 4).

Step 11 of the method MS111 deletes all the temporary files. Upon successful deletion, the flow ends from this step. Step 11 is executed on Operation Processor 16 (vide FIG. 4).

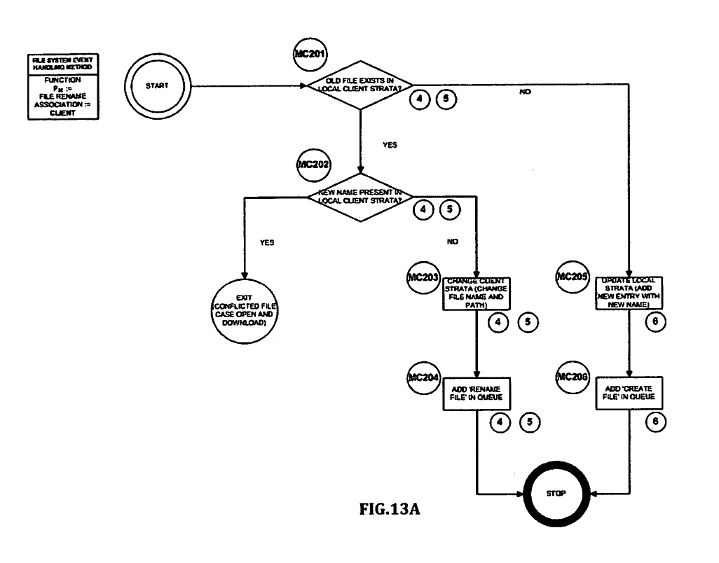

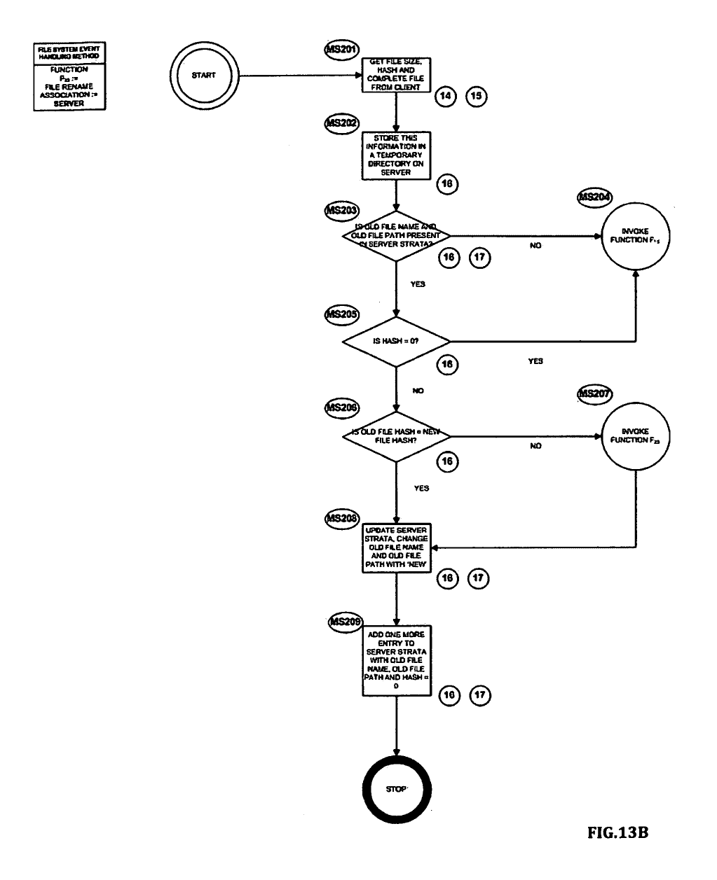

FIG. 13A is a process flow diagram that illustrates the method of handling a file rename event on the client side in accordance with this invention.

The embodiment of the method of handling a file rename event associated with the client side is a Function F_{3C} that comprises a sequence of method steps as shown in FIG. 13A. Function F_{3C} corresponds to User Operation “File Rename” that is executed on Virtual Hard Drive VHD 1 (vide FIG. 4).

Step 1 of the method MC201 determines whether the old file exists in the local client strata. Upon a Yes, the flow passes on to MC202. Upon a No, the flow passes on to MC205. Step 1 is executed on Event Processor 4 and Client Strata 5 (vide FIG. 4).

Step 2 of the method MC202 determines if the new file name is present in the local client strata upon confirmation that the old file exists in the local client strata. Upon a Yes, the User Operation is exited due to file open and download conflict and handled accordingly. Upon a No, the flow passes on to MC203. Step 2 is executed on Event Processor 4 and Client Strata 5 (vide FIG. 4).

Step 3 of the method MC203 effects a change in the client strata by changing the file name and file path. Upon successful and correct change of the file name and file path, the flow passes on to MC204. Step 3 is executed on Event Processor 4 and Client Strata 5 (vide FIG. 4).

Step 4 of the method MC204 inserts a ‘File Rename’ on the ClientReqAcceptor Q1 (vide FIG. 4) queue. The flow ends from this step. Step 4 is executed on Event Processor 4 and Client Strata 5 (vide FIG. 4).

Step 5 of the method MC205 updates local client strata with new file name entry under confirmation that the old file does not reside in local client strata. Upon successful and correct update, the flow passes on to MC206. Step 5 is executed on File Uploader 6 (vide FIG. 4).

Step 6 of the method MC206 inserts a ‘File Create’ on the FileUploadQueue Q2 (vide FIG. 4). The flow ends from this step. Step 6 is executed on File Uploader 6 (vide FIG. 4).

FIG. 13B is a process flow diagram that illustrates the method of handling a file rename event on the server side in accordance with this invention.

The embodiment of the method of handling a file rename event associated with the server side is a Function F_{3S} that comprises a sequence of method steps as shown in

FIG. 13B. Function F_{3S} corresponds to User Operation “File Rename” that is executed on Virtual Hard Drive VHD 1 (vide FIG. 4).

Step 1 of the method MS201 retrieves the file from the client and extracts file size and hash value from the file parameters. Upon successful file retrieval and relevant file parameter extraction, the flow passes on to MS202. Step 1 is executed on Listener 14 and Message Decoder 15 (vide FIG. 4).

Step 2 of the method MS202 stores the retrieved file and the relevant file parameters in a temporary directory on the server. Upon successful execution of this step, the flow passes on to MS203. Step 2 is executed on Operation Processor 16 (vide FIG. 4).

Step 3 of the method MS203 determines the presence of the old file name and old file path in the server strata. Upon a No, the flow passes on to MS204. Upon a Yes, the flow passes on to MS205. Step 3 is executed on Operation Processor 16 and Server Strata 17 (vide FIG. 4).

Step 4 of the method MS204 is an exact replica of the method of handling a file create event on the server side in accordance with this invention. Function F_{1S} is invoked and the corresponding method steps executed.

Step 5 of the method MS205 determines if the extracted hash value of the retrieved file is zero. Upon a Yes, the flow passes back to MS204, invoking Function F_{1S}. Upon a No, the flow passes on to MS206. Step 5 is executed on Operation Processor 16 (vide FIG. 4).

Step 6 of the method MS206 determines if the new hash value equals the old hash value. Upon a No, the flow passes on to MS207. Upon a Yes, the flow passes on to MS208. Step 6 is executed on Operation Processor 16 (vide FIG. 4).

Step 7 of the method MS207 is an exact replica of the method of handling a file modify event on the server side in accordance with this invention. Function F_{2S} is invoked and the corresponding method steps executed. Upon successful execution of the method steps, the flow passes on to MS208.

Step 8 of the method MS208 updates the server strata and substitutes the old file name and old file path with the new file name and new file path. Upon successful update, the flow passes on to MS209. Step 8 is executed on Operation Processor 16 and Server Strata 17 (vide FIG. 4).

Step 9 of the method MS209 adds one more entry to the server strata with the old file name, old file path and the old hash value. The flow ends from this step. Step 9 is executed on Operation Processor 16 and Server Strata 17 (vide FIG. 4).

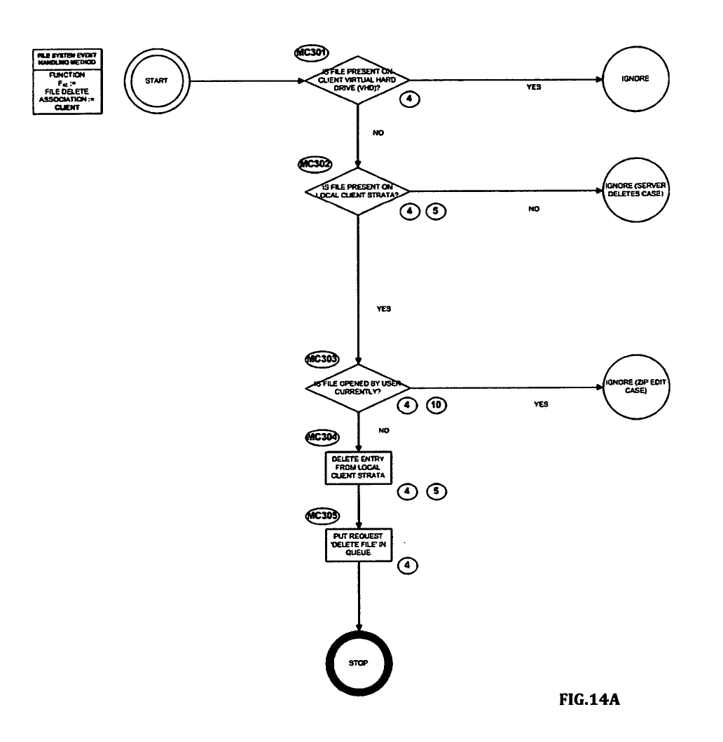

FIG. 14A is a process flow diagram that illustrates the method of handling a file delete event on the client side in accordance with this invention.

The embodiment of the method of handling a file delete event associated with the client side is a Function F_{4C} that comprises a sequence of method steps as shown in FIG. 14A. Function F_{4C} corresponds to User Operation “File Delete” that is executed on Virtual Hard Drive VHD 1 (vide FIG. 4).

Step 1 of the method MC301 determines the presence of the file on the client's Virtual Hard Drive VHD 1 (vide FIG. 4). Upon a Yes, the User Operation is ignored. Upon a No, the flow passes on to MC302. Step 1 is executed on Event Processor 4 (vide FIG. 4).

Step 2 of the method MC302 determines the presence of the file on the local client strata. Upon a Yes, the flow passes on to MC303. Upon a No, the User Operation is ignored as the server deletes the case. Step 2 is executed on Event Processor 4 and Client Strata 5 (vide FIG. 4).

Step 3 of the method MC303 determines if the file is currently opened by a user. Upon a Yes, the User Operation is ignored. Upon a No, the flow passes on to MC304. Step 3 is executed on Event Processor 4 and Open File DB 10 (vide FIG. 4).

Step 4 of the method MC304 deletes the entry from the local client strata. Upon successful deletion, the flow passes on to MC305. Step 4 is executed on Event Processor 4 and Client Strata 5 (vide FIG. 4).

Step 5 of the method MC305 inserts a ‘File Delete’ request in ClientReqAcceptor Q1 (vide FIG. 4) queue. The flow ends from this step. Step 5 is executed on Event Processor 4 (vide FIG. 4).

FIG. 14B is a process flow diagram that illustrates the method of handling a file delete event on the server side in accordance with this invention.

The embodiment of the method of handling a file delete event associated with the server side is a Function F_{4S} that comprises a sequence of method steps as shown in FIG. 14A. Function F_{4S} corresponds to User Operation “File Delete” that is executed on Virtual Hard Drive VHD 1 (vide FIG. 4).

Step 1 of the method MS301 marks the file hash code as zero. The flow passes on to MS302. Step 1 is executed on Operation Processor 16 and Server Strata 17 (vide FIG. 4).

Step 2 of the method MS302 deletes the file from bucket for each corresponding file entry in the server strata. Upon successful deletion, the flow passes on to MS303. Step 2 is executed on Server Strata 17 and Bucket 18 (vide FIG. 4).

Step 3 of the method MS303 compares the client strata with the server strata in terms of file entry records. Upon successful compare, the flow passes on to MS304. Step 3 is executed on Strata Downloader 12 and Strata Comparator 11 (vide FIG. 4).

Step 4 of the method MS304 updates the strata. Upon successful and correct update, the flow passes on to MS305. Step 4 is executed on Client Strata 5 (vide FIG. 4).

Step 5 of the method MS305 deletes the file from the client's virtual hard drive VHD 1 (vide FIG. 4). The flow ends from this step. Step 5 is executed on VHD 1 and File Operation Processor 15 (vide FIG. 4).

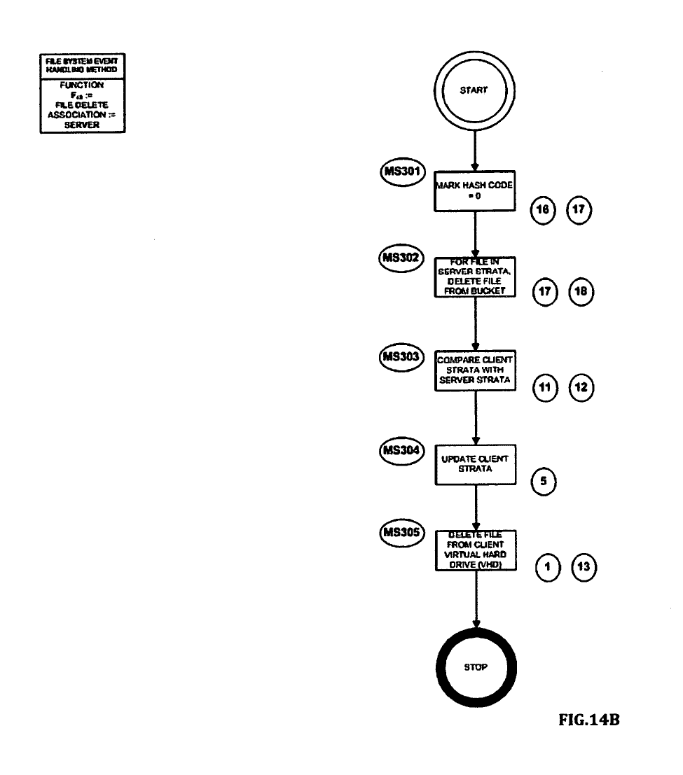

FIG. 15A is a process flow diagram that illustrates the method of handling a file edit event on the client side in accordance with this invention.

The embodiment of the method of handling a file edit event associated with the client side is a Function F_{5C} that comprises a sequence of method steps as shown in FIG. 15A. Function F_{5C} corresponds to User Operation “File Edit” that is executed on Virtual Hard Drive VHD 1 (vide FIG. 4).

Step 1 of the method MC401 determines if the file opened by the user is closed. Upon a Yes, the flow passes on to MC402. Upon a No, the system loops through till the file opened by the user is closed. Step 1 is executed on Open File Identifier 8 (vide FIG. 4).

Step 2 of the method MC402 determines if a file update is pending upon closure. Upon a Yes, the User Operation is ignored. Upon a No, the flow passes on to MC403. Step 2 is executed on Open File Processor 7 (vide FIG. 4).

Step 3 of the method MC403 opens the file and retrieves the relevant hash value. Upon successful retrieval of the hash value, the flow passes on to MC404. Step 3 is executed on Open File Processor 7 (vide FIG. 4).

Step 4 of the method MC404 determines if the file is present on the local client strata. Upon a Yes, the flow passes on to MC405. Upon a No, the flow passes on to MC408. Step 4 is executed on Client Strata 5 (vide FIG. 4).

Step 5 of the method MC405 determines the difference in the retrieved hash value with the original file hash value. If the two are determined different, the flow passes on to MC406. If the two are not determined different, the User Operation is ignored (there being no ‘File Edit’ command upon the equality of the hash values in question) and the flow ends from this step. Step 5 is executed on Open File Processor 7 (vide FIG. 4).

Step 6 of the method MC406 updates the local client strata upon determination of the difference in retrieved hash value and the original hash value of the file associated with this User Operation. Upon the successful and correct update of the client strata, the flow passes on to MC407. Step 6 is executed on Client Strata 5 and Open File Processor 7 (vide FIG. 4).

Step 7 of the method MC407 inserts a ‘File Modify’ request on FileUploadQueue Q2 (vide FIG. 4) upon the successful and correct update of the client strata. Step 7 is executed on File Uploader 6 (vide FIG. 4).

Step 8 of the method MC408 inserts a new row for file entry upon determination that the file associated with this User Operation is not present on the local client strata.

Upon successful insertion of the new row, the flow passes on to MC409. Step 8 is executed on Client Strata 5 (vide FIG. 4).

Step 9 of the method MC409 inserts a ‘File Create’ request on FileUploadQueue Q2 (vide FIG. 4) upon the successful insert of the new row. Step 9 is executed on File Uploader 6 (vide FIG. 4).

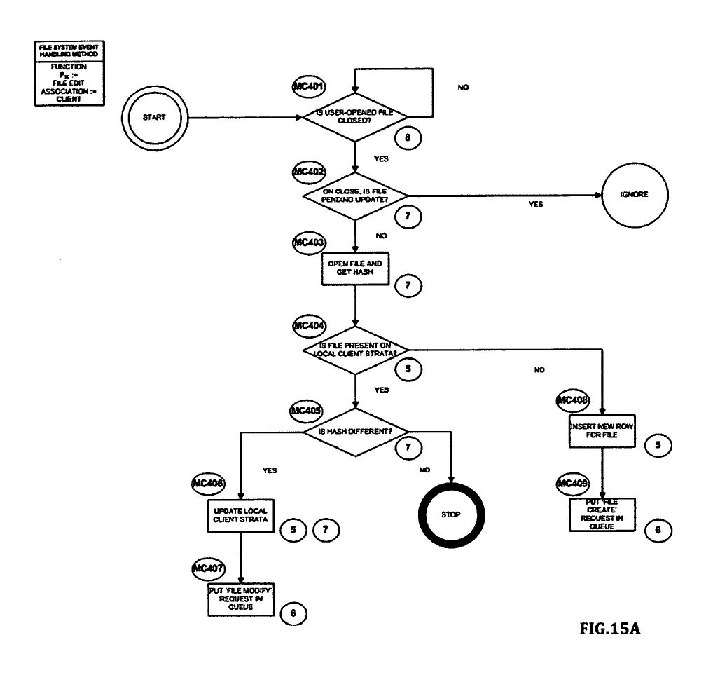

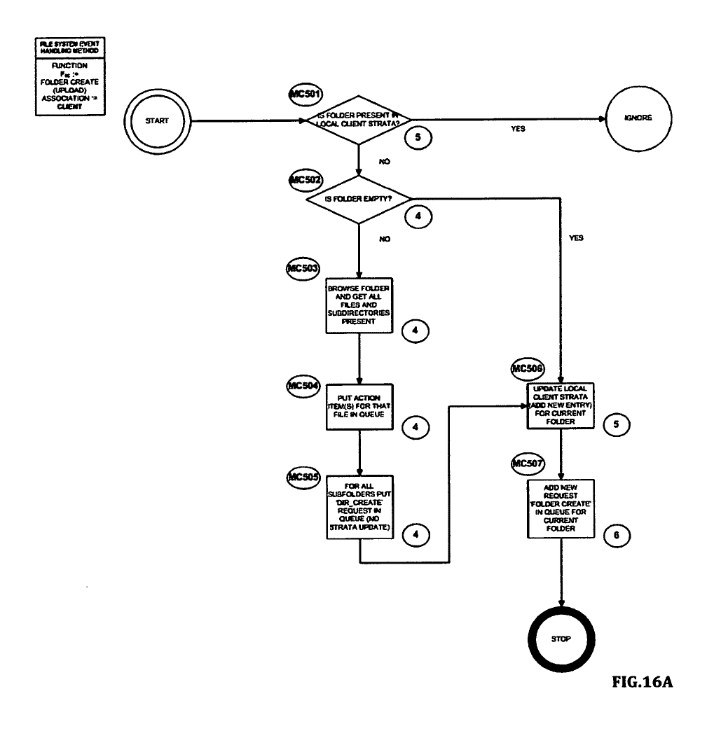

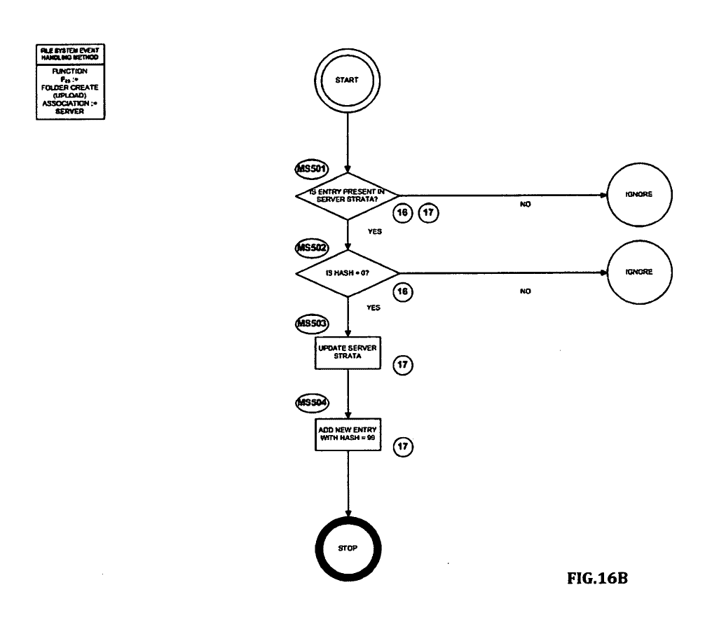

FIG. 16A is a process flow diagram that illustrates the method of handling a folder create event on the client side in accordance with this invention.

The embodiment of the method of handling a folder create event associated with the client side is a Function F_{6C} that comprises a sequence of method steps as shown in FIG. 16A. Function F_{6C} corresponds to User Operation “Folder Create” that is executed on Virtual Hard Drive VHD 1 (vide FIG. 4).

Step 1 of the method MC501 determines the folder's presence on local client strata. Upon a Yes, the User Operation is ignored as the folder in question to be created already exists. Upon a No, the flow passes on to MC502. Step 1 is executed on Client Strata 5 (vide FIG. 4).

Step 2 of the method MC502 determines the emptiness of the folder upon determination that the folder associated with the User Operation is not present on local client strata. If the folder is empty, the flow passes on to MC506. If the folder is not empty, the flow passes on to MC503. Step 2 is executed on Event Processor 4 (vide FIG. 4).

Step 3 of the method MC503 involves browsing the folder and retrieving all files and subdirectories present in the folder associated with the User Operation. Upon successful and correct retrieval of all the folder components, the flow passes on to MC504. Step 3 is executed on Event Processor 4 (vide FIG. 4).

Step 4 of the method MC504 inserts the relevant requests for each of the folder components on ClientReqAcceptor Q1 (vide FIG. 4) upon the successful and correct retrieval of all the folder components. Upon the relevant request insertion completion, the flow passes on to MC505. Step 4 is executed on Event Processor 4 (vide FIG. 4).

Step 5 of the method MC505 inserts a ‘Directory Create’ request on ClientReqAcceptor Q1 (vide FIG. 4) for each subdirectory of the folder associated with the User Operation. This step does not upload the local client strata. Step 5 is executed on Event Processor 4 (vide FIG. 4).

Step 6 of the method MC506 updates the local client strata by adding a new entry for the current folder. Upon successful update of the local client strata, the flow passes on to MC507. Step 6 is executed on Client Strata 5 (vide FIG. 4).

Step 7 of the method MC507 inserts a ‘Folder Create’ request FileUploadQueue Q2 (vide FIG. 4) upon the successful update of the local client strata. The flow ends from this step. Step 7 is executed on File Uploader 6 (vide FIG. 4).

FIG. 16B is a process flow diagram that illustrates the method of handling a folder create event on the server side in accordance with this invention.

The embodiment of the method of handling a folder create event associated with the server side is a Function F_{6S} that comprises a sequence of method steps as shown in FIG. 16B. Function F_{6S} corresponds to User Operation “Folder Create” that is executed on Virtual Hard Drive VHD 1 (vide FIG. 4).

Step 1 of the method MS501 determines the folder's presence on local server strata. Upon a No, the User Operation is ignored. Upon a Yes, the flow passes on to MS502. Step 1 is executed on Operation Processor 16 and Server Strata 17 (vide FIG. 4).

Step 2 of the method MS502 determines if the hash value of the retrieved folder is zero upon the determination of the folder's presence of the local server strata. If the hash value is non-zero, the User Operation is ignored. If the hash value is zero, the flow passes on to MS503. Step 2 is executed on Operation Processor 16 (vide FIG. 4).

Step 3 of the method MS503 updates the local server strata. Upon the successful and correct update of the server strata, the flow passes on to MS504. Step 3 is executed on Server Strata 17 (vide FIG. 4).

Step 4 of the method MS504 adds a new entry to the server strata with a hash value of 99. Upon completion of the new entry to the strata, the flow ends from this step. Step 4 is executed on Server Strata 17 (vide FIG. 4).

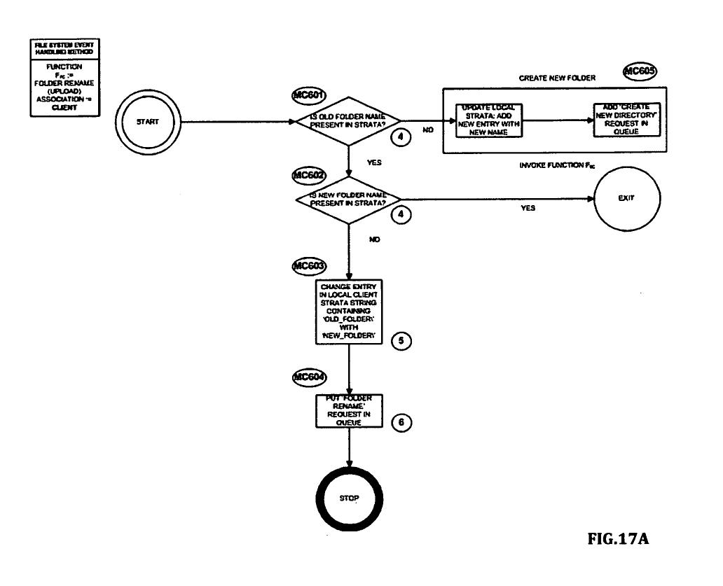

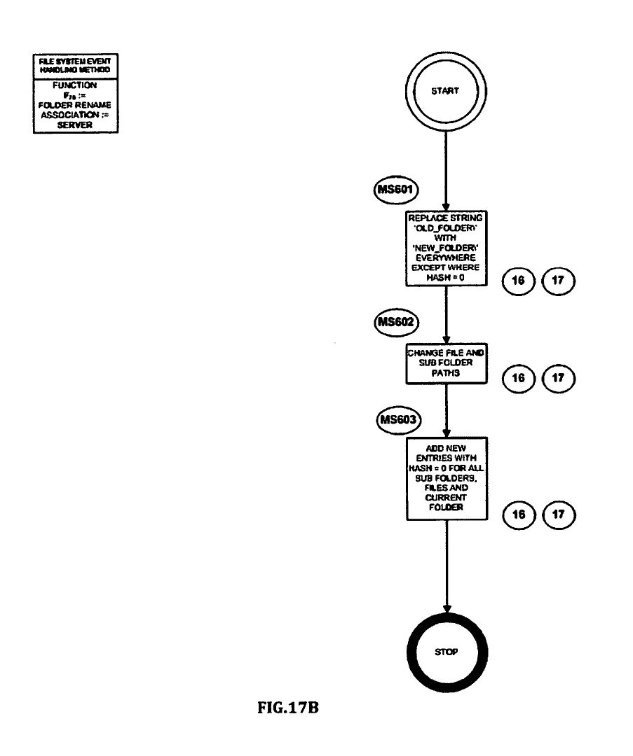

FIG. 17A is a process flow diagram that illustrates the method of handling a folder rename on the client side in accordance with this invention.

The embodiment of the method of handling a folder rename event associated with the client side is a Function F_{7C} that comprises a sequence of method steps as shown in FIG. 17A. Function F_{7C} corresponds to User Operation “Folder Rename” that is executed on Virtual Hard Drive VHD 1 (vide FIG. 4).

Step 1 of the method MC601 determines if the old folder name is present on the local client strata for the associated User Operation. Upon a No, the flow passes on to MC605. Upon a Yes, the flow passes on to MC602. Step 1 is executed on Event Processor 4 (vide FIG. 4).

Step 2 of the method MC602 determines if the new folder name is present on the local client strata for the associated User Operation. Upon a Yes, the User Operation is ignored. Upon a No, the flow passes on to MC603. Step 2 is executed on Event Processor 4 (vide FIG. 4).

Step 3 of the method MC603 changes the entry in local client strata string containing the old folder name with the new folder name. Step 3 is executed on Client Strata 5 (vide FIG. 4).

Step 4 of the method MC604 inserts a ‘Folder Rename’ request on FileUploadQueue Q2 (vide FIG. 4) upon the successful change of the local client strata. The flow ends from this step. Step 4 is executed on File Uploader 6 (vide FIG. 4).

Step 5 of the method MC605 is an exact replica of the method of handling a folder create event on the client side in accordance with this invention. Function F_{6C} is invoked and the corresponding method steps executed.

FIG. 17B is a process flow diagram that illustrates the method of handling a folder rename event on the server side in accordance with this invention.

The embodiment of the method of handling a folder rename event associated with the server side is a Function F_{7S} that comprises a sequence of method steps as shown in FIG. 17B. Function F_{7S} corresponds to User Operation “Folder Rename” that is executed on Virtual Hard Drive VHD 1 (vide FIG. 4).

Step 1 of the method MS601 replaces the string of the old folder name with the new folder name for all files and subdirectories except where the hash value is zero. Upon successful replacement, the flow passes on to MS602. Step 1 is executed on Operation Processor 16 and Server Strata 17 (vide FIG. 4).

Step 2 of the method MS602 changes the file and all subfolder paths. Upon successful and correct change, the flow passes on to MS603. Step 2 is executed on Operation Processor 16 and Server Strata 17 (vide FIG. 4).

Step 3 of the method MS603 adds new entries for those with zero hash values for all sub-folders, files and the current folder. Upon successful addition, the flow ends from this step. Step 3 is executed on Operation Processor 16 and Server Strata 17 (vide FIG. 4).

### Front Page Margins Disclaimer

Profit margin figures are included for information purposes only. These figures provide an estimated guide only and are not guaranteed by Network2Share. This estimate is based on the per licence purchase price and current market prices for related products and services as at November 2015.

### Resellers Page Margins Copy

### Staggeringly High Margins

Why settle for a 15% margin? Sell CloudFileSync and you could earn profit margins of up to 300%*.
*Profit margin figures are included for information purposes only. These figures provide an estimated guide only and are not guaranteed by Network2Share. This estimate is based on the per licence purchase price and current market prices for related products and services as at November 2015.

1. A method (realizable as executable code for computer software in a machine readable form) for precise detection of file system events, the said method comprising the steps of:
a. Identifying and isolating a single file system event from an automatically-generated set of multiple file system events
b. Mapping associatively a single file system event to the corresponding user operation from an assortment of automatically-generated set of multiple file system events

2. The method as stated in claim 1, wherein identifying and isolating a single file system event from an automatically-generated set of multiple file system events comprise the steps of:
a. Designing a file systems event profiler

3. The method as stated in claim 1, wherein mapping associatively a single file system event to the corresponding user operation from an assortment of automatically-generated set of multiple file system events comprise the steps of:
a. Designing methods to associate reduced event set variables with user operations

4. The method as stated in claim 2, wherein designing a file systems event profiler comprises the steps of:
a. Designing methods to filter automatically-generated set of multiple file system events

5. The method as stated in claim 2, where designing a file systems event profiler comprises the steps of:
a. Designing methods of handling file system events

6. The method as stated in claim 3, where designing methods to associate reduced event set variables with user operations comprise the steps of:
a. Designing methods to handle a set of file system events for a plurality of user operations (e.g. ‘file create’, ‘file rename’ et al.)

7. The method as stated in claim 3, where designing methods to associate reduced event set variables with user operations comprise the steps of:
a. Designing methods to handle a set of file system events for different user operation cases (e.g. ‘file create’, ‘file rename’ et al.) for different file types (e.g. Microsoft PowerPoint, Microsoft Word, PDF et al.)
